(19) United States
(12) Patent Application Publication
(10) Pub. No.: US 2007/0066697 A1
(43) Pub. Date: Mar. 22, 2007

(54) Strut-reinforced polyurethane foam

(76) Inventors: Stephen D. Gilder, Chula Vista, CA (US); William A. Griggs, Southhaven, MS (US)

Correspondence Address: CONLEY ROSE, P.C., 5700 GRANITE PARKWAY, SUITE 330, PLANO, TX, 75024, US

(21) Appl. No.: 11/515,458

(22) Filed: Aug. 31, 2006

Related U.S. Application Data
(60) Provisional application No. 60/713,202, filed on Aug. 31, 2005.

(51) Int. Cl. C08J 9/00

(52) U.S. Cl. 521/99

(57) ABSTRACT

A polyurethane produced from a formulation comprising a polyol, an isocyanate and a strut reinforcing agent. The isocyanate reacts with the polyol to produce the polyurethane foam. By including the strut reinforcing agent in the formulation during the reaction between the isocyanate and the polyol enhances the air permeability and firmness of the polyurethane foam relative to a polyurethane foam produced by reacting the isocyanate and the polyol in the absence of the strut reinforcing agent.

### CROSS-REFERENCE TO RELATED APPLICATIONS

This application is related to and claims priority from U.S. Provisional Application 60/713,202 filed Aug. 31, 2005 and hereby incorporated by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present disclosure is generally directed to flexible polyurethane foam products and, more specifically, to flexible polyurethane foam products made from a formulation containing a strut-reinforcing agent.

### BACKGROUND

Polyurethane foam is produced by mixing isocyanate, polyol and water to create two simultaneous reactions: a gelling (or polymerization) reaction and a blowing (or gas-producing) reaction. The gelling reaction occurs when the isocyanate reacts with the polyol to form urethane chains. The blowing reaction occurs when the isocyanate reacts with the water to form carbon dioxide gas. The urethane chains make up the structure of the foam, while the carbon dioxide gas creates porosity within the foam by expanding the polyurethane polymer. Numerous additives are mixed with the isocyanate, polyol, and water to control the rate and duration of the gelling and blowing reactions, while also providing a mechanism for urethane chain cross-linking and chain extension. By controlling the rate and duration of the gelling and blowing reactions, a polyurethane foam production facility can control the physical properties of the foam so that the foam meets a desired set of specifications. When the gelling and blowing reactions are completed and the foam has had sufficient time to fully cure, the resulting polyurethane foam may be processed into various polyurethane foam products.

The blowing and gelling reactions hereinabove described produce a plurality of cells within the polyurethane foam. FIGS. 1A, 1B, and 1C are three examples of polyurethane foam cells 50. The cells 50 are defined by a plurality of struts 54 that provide structural support for the cell 50. Once the struts 54 are sufficiently hardened, the struts 54 prevent the cell 50 from collapsing when the cell 50 is subjected to a compressive force. The areas between the struts 54 are referred to as windows 52. When the windows 52 contain a membrane 56, as shown in FIG. 1A, the cell 50 is referred to as a closed cell. In contrast, when one or more of the windows 52 lack membranes 56, as shown in FIG. 1B, the cell 50 is referred to as an open cell. Some open cells may have one or more flap-like partial membranes 58 that are created when a membrane 56 ruptures. The most common example of a cell is one that lack membranes, windows 52 that contain membranes 54 and windows that contain partial membranes 58. Such a cell is shown in FIG. 1C.

In many applications, for example, bedding and filtration applications, involving the use of polyurethane foam, it is generally considered advantageous to maximize the presence of open cells within the polyurethane foam. One of the problems associated with the use of polyurethane foam in bedding and filtration applications is that the membranes and partial membranes within the polyurethane foam limit the ability of air to circulate within the polyurethane foam. As a result, polyurethane foam has relatively poor air permeability characteristics when compared to other types of support and filtration media such as nonwoven fiber batts. In addition, the membranes and partial membranes impede the flow of gas or liquid through the polyurethane foam, thereby creating problems for filtration applications and encouraging microbial growth. Finally, the membranes and partial membranes do little to increase the structural capacity of the polyurethane foam. Polymer material that could have been deposited onto the struts, thereby increasing the structural capacity of the polyurethane foams, but instead formed membranes and partial membranes should be considered as having been wasted.

The desirability of polyurethane foam having increased amounts of polyurethane material in the struts and/or decreased amounts of polyurethane material in the windows should be readily appreciated by those skilled in the art. Disclosed herein is such a polyurethane foam.

### SUMMARY

In one embodiment, disclosed herein is a polyurethane foam produced from a formulation comprised of a polyol, an isocyanate and a strut reinforcing agent non-reactive relative to the polyol and the isocyanate. The isocyanate reacts with the polyol to produce the polyurethane foam. By including the strut reinforcing agent in the formulation, the polyurethane foam resulting from the reaction of the isocyanate and the polyol has enhanced air permeability relative to a polyurethane foam produced by the reaction of the isocyanate and the polyol in the absence of the strut reinforcing agent. In various aspects thereof, the strut reinforcing agent may be an aromatic hydrocarbon, an aromatic hydrocarbon comprising at least about 10 carbon atoms, an organic chemical compound comprising at least about 10 carbon atoms, a mineral oil, paraffin, naphthalene or a vegetable oil.

In another embodiment, disclosed herein is a polyurethane foam produced from a formulation comprised of a polyol, an isocyanate and a strut reinforcing agent. The isocyanate reacts with the polyol to produce the polyurethane foam. By including the strut reinforcing agent in the formulation, the polyurethane foam resulting from the reaction of the isocyanate and the polyol has enhanced firmness relative to a polyurethane foam produced by the reaction of the isocyanate and the polyol in the absence of the strut reinforcing agent. In various aspects thereof, the strut reinforcing agent may be an aromatic hydrocarbon, an aromatic hydrocarbon comprising at least about 10 carbon atoms, an organic chemical compound comprising at least about 10 carbon atoms, a mineral oil, paraffin, naphthalene or a vegetable oil.

In still another embodiment, disclosed herein is polyurethane foam produced from a formulation comprised of about 100 parts of a polyol, between about 40 and about 60 parts of an isocyanate and between about 2 and about 8 parts of a strut reinforcing agent. The isocyanate reacts with the polyol to produce the polyurethane foam. By including the strut reinforcing agent in the formulation, the polyurethane foam resulting from the reaction of the isocyanate and the polyol has enhanced air permeability and firmness relative to a polyurethane foam produced by the reaction of the isocyanate and the polyol in the absence of the strut reinforcing agent. In one aspect thereof, the formulation further comprises between about 0.01 parts and about 3 parts of a surfactant.

### BRIEF DESCRIPTION OF THE DRAWINGS

For a more complete understanding of the present disclosure, and for further details and advantages thereof, reference is now made to the accompanying drawings, in which:

FIG. 1A is an enlarged view of a closed cell polyurethane foam;

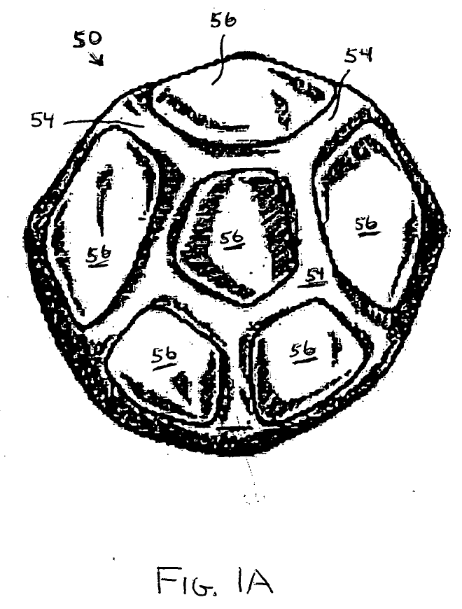

FIG. 1B is an enlarged view of a first open cell polyurethane foam;

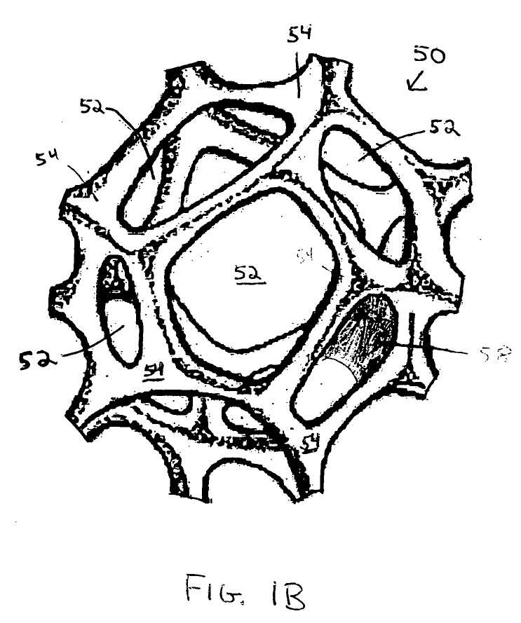

FIG. 1C is an enlarged view of a second open cell polyurethane foam;

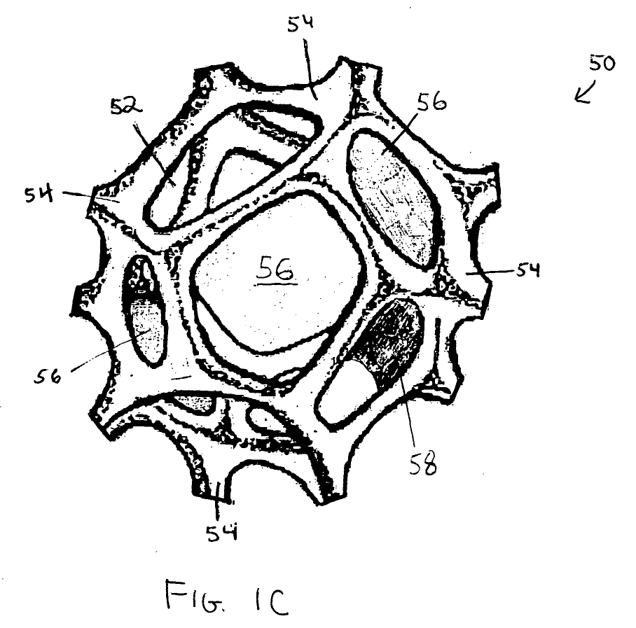

FIG. 2 is a block diagram of a method for producing a strut-reinforced polyurethane foam;

FIG. 3 is a schematic view of an apparatus for producing a strut-reinforced polyurethane foam;

FIG. 4A is a graphical illustration comparing the percent loss of the 65% IFD of a strut-reinforced polyurethane foam to the percent retention of the 65% IFD of first and second conventional polyurethane foams;

FIG. 4B is a graphical illustration comparing the percent retention of the 65% IFD of a strut-reinforced polyurethane foam to the percent retention of the 65% IFD of first and second conventional polyurethane foams;

FIG. 5 is a graphical illustration comparing dynamic fatigue of a strut-reinforced polyurethane foam to dynamic fatigue of first and second conventional polyurethane foams;

FIG. 6 is a graphical illustration comparing roller shear fatigue of a strut-reinforced polyurethane foam to roller shear fatigue of a conventional polyurethane foam;

FIG. 7A is a graphical illustration comparing the percentage loss of the 25% IFD of a strut-reinforced polyurethane foam to the percentage loss of the 25% IFD of first and second conventional polyurethane foams;

FIG. 7B is a graphical illustration comparing the percentage loss of the 65% IFD of a strut-reinforced polyurethane foam to the percentage loss of the 65% IFD of first and second conventional polyurethane foams;

FIG. 7C is a graphical illustration comparing the percentage retention of the 25% IFD of a strut-reinforced polyurethane foam to the percentage retention of the 25% IFD of first and second conventional polyurethane foams; and

FIG. 7D is a graphical illustration comparing the percentage retention of the 65% IFD of a strut-reinforced polyurethane foam to the percentage retention of the 65% IFD of first and second conventional polyurethane foams.

### DETAILED DESCRIPTION

Disclosed herein is a polyurethane foam with improved properties and a formulation for producing the foam. Generally, polyurethane foam is produced by the reaction of a polyol, isocyanate and water. As disclosed herein, the formulation includes a strut reinforcing agent that allows the polymer material to drain from the windows to the struts during the formation of the polyurethane foam, thereby reinforcing the struts and opening the majority of the cells. The concurrent reinforcement of the struts and opening of the cells results in a polyurethane foam having superior physical properties.

The strut reinforcing agent included in the formulation is any chemical compound that substantially reduces or eliminates the presence of membranes or partial membranes within the polyurethane foam cells. In one embodiment, the strut reinforcing agent is a chemical compound that does not react with the other components of the polyurethane foam formulation, such as the isocyanate and the polyol. Because the gelling reaction in an alkaline reaction, the presence of an acidic solution retards the rate of the gelling reaction, which can cause the polyurethane foam to split or collapse. Likewise, the presence of an alkaline solution increases the rate of the gelling reaction, which can lead to scorching and other exothermic problems. Thus, it is generally preferable to have a strut reinforcing agent having a pH near the natural pH of the gelling reaction. The acid number represents the acidity of a solution; specifically, the acid number measures the amount of potassium hydroxide required to neutralize one gram of the strut reinforcing agent, and is generally expressed as mp KOH/g. It has been found that strut reinforcing agents having acid numbers of about 1 mg KOH/g or less, about 0.25 mg KOH/g or less, or about 0.05 mg KOH/g or less are suitable for use with the polyurethane foam.

Various petroleum-based strut reinforcing agents are suitable for use in the formulation. As it has an acid number less than 0.05 mg KOH/g, mineral oil is a suitable strut reinforcing agent. For example, a mineral oil having an acid number of 0.01 mg KOH/g and marketed under the name FLUIDAL 500 N by Fluids, Incorporated of Vicksburg, Miss. would be suitable for the uses disclosed herein. Another example of a suitable strut reinforcing agent is a heavy petroleum distillate, such as paraffin. In embodiments thereof, the heavy petroleum distillate includes saturated and unsaturated hydrocarbon chains with from about ten to about seventy carbon atoms, saturated and unsaturated hydrocarbon chains with from about twenty to about fifty carbon atoms, and aromatic hydrocarbons, such as naphthalene. In other embodiments thereof, the strut reinforcing agent may also include aromatic hydrocarbons containing from about ten to about seventy carbon atoms, or from about twenty to about fifty carbon atoms. These heavy petroleum distillates may also be hydro-treated, if desired.

In alternative embodiments thereof, other types of oils may be used as the strut reinforcing agent. Other suitable oils include vegetable oil, soy oil, castor oil, safflower oil, sesame oil, peanut oil, cottonseed oil, olive oil, linseed oil, palm oil, vegetable oil, canola oil, and blends thereof. However, care must be exercised when utilizing these oils because many of the aforementioned oils are alkaline solutions that contain active hydroxyl (OH) groups which will react with any available isocyanate. In such embodiments, the pH of the formulation may need to be adjusted (e.g. by varying the amount of polyol or pH altering additives in the formulation) to allow for the increase in reaction rate, thereby preventing scorching and other exothernic problems. In still other embodiments thereof, the strut reinforcing agent can be silicone-based oil. Of course, the strut reinforcing agents described herein are identified for purely exemplary purposes and it is fully contemplated that the polyurethane foam may instead include suitable strut reinforcing agents other than those specifically disclosed herein.

Depending on the application, the amount of strut reinforcing agent present in the polyurethane foam may vary. In embodiments thereof, the formulation includes from about 0.01 parts per hundred (pph) to about 100 pph, from about 1 pph to about 25 pph, or from about 2 pph to about 8 pph of the strut reinforcing agent. If the weight percent of the strut reinforcing agent is desired, then 100 times the amount of the strut reinforcing agent is divided by the sum of the amounts of all of the components of the formulation. In embodiments thereof, the formulation includes from about 0.01 weight percent to about 20 weight percent, from about 0.1 weight percent to about 10 weight percent, or from about 0.8 weight percent to about 4 weight percent strut reinforcing agent is present in the formulation.

The inclusion of the strut reinforcing agent in the formulation improves the air permeability of the polyurethane foam. Air permeability is defined as the ability of air to move freely through the polyurethane foam. An increased amount of open cells within the polyurethane foam and/or a decreased amount of membranes and partial membranes improve the air permeability of the polyurethane foam. Air permeability is also affected by the density, firmness, and type (e.g. conventional, HR, or viscoelastic) of polyurethane foam. Air permeability of at least about 4 cubic feet per minute (cfm) is generally considered acceptable for many types of filtration applications. The air permeability may be measured using a Gulbrandsen foam porosity tester in accordance with ASTM D 3574-03, test G. Specifically, test G measures the air permeability through the top to the bottom of a 51 millimeter (mm)×51 mm×25 mm block of foam. In embodiments thereof, the air permeability of the polyurethane foam is at least about 4 cfm, at least about 5 cfm, or at least about 6 cfm.

The inclusion of the strut reinforcing agent in the formulation also improves the firmness retention of the polyurethane foam. Firmness retention is defined as the ability of the polyurethane foam to retain its original firmness after being subjected to multiple compressions. The redistribution of polyurethane polymer material from the windows to the struts during the formation of the polyurethane foam improves the firmness retention of the foam. Firmness retention is measured in accordance with ASTM 3574-01, which measures the firmness of the polyurethane foam after being subjected to multiple compressions. In embodiments thereof, the firmness retention of the polyurethane foam is 94 percent after 8,000 cycles, 91 percent after 10,000 cycles, 87 percent after 30,000 cycles, or 84 percent after 50,000 cycles.

The polyol included in the formulation may be any type of polyol, such as diol, triol, tetrol, polyol, or blends thereof and specifically includes both polyether and polyester polyols. Typically, the polyol is selected based on its hydroxyl number, molecular weight and processing conditions. Examples of suitable polyols include: ethylene glycol, propylene glycol, butylene glycol, hexanediol, octanediol, neopentyl glycol, 1,4-bishydroxymethyl cyclohexane, 2-methyl-1,3-propane diol, glycerin, trimethylolethane, hexanetriol, butanetriol, quinol, polyester, methyl glucoside, triethyleneglycol, tetraethylene glycol, polyethylene glycol, dipropylene glycol, polypropylene glycol, diethylene glycol, glycerol, pentaerythritol, trimethylolpropane, sorbitol, mannitol, dibutylene glycol, polybutylene glycol, alkylene glycol, oxyalkylene glycol, ethylene glycol, diethylene glycol, dipropylene glycol, triethylene glycol, tripropylene glycol, tetraethylene glycol, tetrapropylene glycol, trimethylene glycol, tetramethylene glycol, 1,4-cyclohexanedimethanol (1,4-bis-hydroxymethylcyclohexane), vegetable oil polyols, and mixtures thereof. Specific examples of suitable polyols are the VORANOL® line, including 3136, 3137A, and 4001, available from the Dow Chemical Company of Midland, Mich., the ALCUPOL® line of polyols available form Repsol YPF of Madrid, Spain, and one or more of SP-168, SP-170, SP-238, and SP-2744 available from the Peterson Chemical Corporation of Sheboygan, Wis. Of course, the foregoing polyols are purely exemplary and it is fully contemplated that formulation may include suitable polyols other than specifically disclosed herein. Although the amount of polyol included in the formulation may vary, generally the amount of polyol is fixed at one hundred parts such that the other formulation components can be measured relative to the polyol, e.g. in pph.

Isocyanate reacts with the polyol to form the urethane chains, links, or struts within the polyurethane foam and with the water to create gas within the foam. In embodiments thereof, the formulation includes between about 10 pph and about 150 pph of isocyanate, between about 30 pph and about 70 pph of isocyanate or between about 40 pph and about 60 pph of isocyanate. The isocyanate included in the formulation may be any type of isocyanate, such as toluene diisocyanate (TDI), diisocyanatodiphenyl methane (MDI), or blends thereof. A suitable isocyanate is 80/20 TDI, which is a blend comprising 80 percent of the 2, 4 isomer of TDI and 20 percent of the 2, 6 isomer of TDI. Other suitable isocyanates include: m-phenylene diisocyanate, p-phenylene diisocyanate, polymethylene polyphenyl-isocyanate, 2,4-toluene diisocyanate, 2,6-toluene diisocyanate, 4,4- diisocyanatodiphenyl methane, dianisidine diisocyanate, bitolylene diisocyanate, naphthalene-1,4-diisocyanate, diphenylene-4,4′-diisocyanate, xylylene-1,4-diisocyanate, xylylene-1,2-diisocyanate, xylylene- 1,3-diisocyanate, bis(4-isocyanatophenyl)-methane, bis(3-methyl-4-isocyanatophenyl)-methane, 4,4-diphenylpropane diisocyanate, isophorone diisocyanate, hexamethylene diisocyanate, methylene-bis-cyclohexylisocyanate, and mixtures thereof. Specific examples of suitable isocyanates are Suprasec 7050 and 7304 available from Huntsman International LLC of Salt Lake City, Utah or Voranate T-80 available from the Dow Chemical Company of Midland, Mich. Of course, the foregoing isocyanates are purely exemplary and it is fully contemplated that formulation may include suitable isocyanates other than specifically disclosed herein.

One factor affecting the physical properties of the polyurethane foam is the isocyanate index of the formulation. The isocyanate index or merely “the index” is the stoichiometric amount of isocyanate needed to react with the active hydroxide components in the polyol. An index of 100 indicates that the formulation contains stoichiometrically equal amounts of isocyanate and active hydroxide components in the polyol. Indexes less than 100 indicate that the formulation contains an excess amount of polyol, whereas indexes above 100 indicate that the formulation contains an excess amount of isocyanate. Thus, an isocyanate index of 102 means that the formulation contains 102 percent of the amount of isocyanate stoichiometrically required to react with all active hydroxide components in the polyol.

The formulation may also include a blowing agent. In embodiments thereof, the formulation may include between about 0.01 pph and about 50 pph of a blowing agent, between about 0.1 pph and about 20 pph of a blowing agent or between about 1 pph and about 5 pph of a blowing agent. Water is an example of a suitable blowing agent. However, as the blowing reaction between isocyanate and water is exothermic, the use of water as the blowing agent substantially increases the risk of the polyurethane foam scorching, splitting, or igniting. As a result, inert blowing agents, such as CFCs or methylene chloride, have been employed to replace some of the water in the formulation. However, the use of CFCs and methylene chloride in the polyurethane foam is generally discouraged because of the harmful effect that these materials have on the environment. Consequently, in another embodiment, carbon dioxide is used as a blowing agent in place of some or all of the CFCs, methylene chloride and/or water. So that the carbon dioxide remains in a liquid state, it is typically mixed with the other formulation components at high pressure and low temperature. Not only does carbon dioxide act as a blowing agent to rise the polyurethane foam, it also cools the polyurethane foam as it expands, thereby reducing the overall temperature increase of the foam resulting from other exothermic chemical reactions within the polyurethane foam.

The formulation may also include a catalyst. In embodiments thereof, the formulation may include catalysts in an amount between about 0.01 pph and about 10 pph, in an amount between about 0.05 pph and about 1 pph, or in an amount between about 0.2 pph and about 0.5 pph of the catalysts are present in the formulation. Catalysts are generally classified as either blowing catalysts or gelling catalysts, but some catalysts may act as both the blowing catalyst and the gelling catalyst. Blowing catalysts are generally tertiary amine catalysts and primarily catalyze the blowing reaction that creates porosity in the polyurethane foam. Examples of suitable blowing catalysts include: trimethylamine, triethylenediamine, tetramethylethylenediamine, bis (2-dimethylaminoethyl) ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, dimethylethanolamine, tetramethylpropanediamine, methyltriethylenediamine, 2,4,6-tri(dimethylaminomethyl)phenol, dimethylamino pyridine, dimethylaminoethanol, N,N′,N″-tris (dimethylaminopropyl)-sym-hexahydrotriazine, 2-(2-dimethylaminoethoxy)ethanol, tetramethyl propanediamine, trimethylaminoethylethanolamine, dimorpholinodiethylether (DMDEE), N-methylimidazole, dimethylethylethanolamine, methyl triethylenediamine, N-methylmorpholine, and mixtures thereof. Specific examples of suitable blowing catalyst include the NIAX® line, including A33 and A133, available from GE Advanced Materials of Pittsfield, Mass., and the JEFFCAT® line, including ZF-10, available from Huntsman International LLC of Salt Lake City, Utah.

Gelling catalysts are generally organo-tin catalysts and primarily catalyze the gelling reaction that creates the urethane chains, links, or struts within the polyurethane foam. Examples of suitable gelling catalysts include: stannous or stannic compounds, stannous salts of carboxylic acids, stannous acylate, trialkyltin oxide, dialklyltin dihalide, dialkyltin oxide, dibutyltin dilaurate, dibutyltin diacetate, diethyltin diacetate, dihexyltin diacetate, di-2-ethylhexyltin oxide, dioctyltin dioxide, stannous octoate, stannous oleate, and mixtures thereof. Suitable gelling catalysts include: TCAT 110 and TCAT 150, both of which are available from Gulbrandsen Chemicals of La Porte, Texas, and K-19 and K-29, both of which are available from Goldschmidt AG of Essen, Germany. Of course, the foregoing catalysts are purely exemplary and it should be clearly understood that the formulation may include catalysts other than those specifically disclosed herein.

The formulation may also include a surfactant. While the formulation may be substantially free of surfactants, in embodiments thereof, the formulation may include between about 0 parts and about 10 parts of surfactants, between about 0.01 parts and about 5 parts of surfactants, or between about 0.1 parts and about 2.5 parts of surfactants. In further embodiments thereof, the formulation may include between about 0 weight percent and about 10 weight percent of surfactants, between about 0.01 weight percent and about 2.5 weight percent of surfactants or between about 0.1 weight percent and about 0.5 weight percent of surfactants. Surfactants are chemical compounds that affect the surface tension of liquids. Numerous types of surfactants are commercially available, including siloxane polyalkyleneoxide and octamethylcyclotetrasiloxane. A specific example of a suitable surfactant is the NIAX® silicone line of products, including L-618, L-635, or L-650, available from GE Advanced Materials of Pittsfield, Mass. Of course, the foregoing surfactants are purely exemplary and it should be clearly understood that the formulation may include surfactants other than those specifically disclosed herein.

The formulation may also include a foam processing aid. In embodiments thereof, the formulation may include between about 0 parts and about 10 parts of a foam processing aid, between about 0.01 parts and about 5 parts of a foam processing aid or between about 0.1 parts and about 2.5 parts of a foam processing aid. In further embodiments thereof, the formulation may include between about 0 weight percent and about 10 weight percent of a foam processing aid, between about 0.01 weight percent and about 2.5 weight percent of a foam processing aid or between about 0.1 weight percent and about 0.5 weight percent of a foam processing aid. Foam processing aids are chemical compounds or chemical compound blends that improve the foaming properties of foam producing formulations. Generally, foam processing aids are blends of high hydroxyl number polyether or polyester polyols with other substances, such as dimethylcyclohexylamine and dipropylene glycol. Suitable foam processing aids include the GEOLITE® modifier line, including GM-206 and GM-210, and the NIAX(® modifier line, including DP-1022, both of which are available from GE Advanced Materials of Pittsfield, Massachusetts. Another suitable foam processing aid is SP-370 available from Peterson Chemical Corporation of Sheboygan, Wisconsin. Of course, the foregoing foam processing aids are purely exemplary and it should be clearly understood that the formulation may include foam processing aids other than those specifically disclosed herein.

The formulation may also include one or more other additives that individually or collectively improve one or more characteristics of the polyurethane foam. These additives may include: flame retardants, antimicrobial chemical compounds, antioxidants, pigments, dyes, cross-linkers, stabilizers, and chain extenders. Of the foregoing types of additives, flame retardant (FR) chemical compounds, such as melamine, expandable graphite, or dibromoneopentyl glycol, improve the flame retardant properties of the foam product. Suitable FR agents include FM-552 available from Great Lakes Chemical Corporation of El Dorado Ark. and the FYROL line, including HF-4, available from Supresta LLC of Ardsley, N.Y. Antimicrobial additives, such as zinc pyrithione, improve the antimicrobial properties of the polyurethane foam. An antimicrobial compound which improves the antimicrobial properties of the polyurethane foam and is suitable for use as an additive to the formulation is UltraFresh DM-50 available from Thompson Research Associates of Toronto, Canada. Various antioxidants and/or anti-scorch additives such as CS-15 available from GE Advanced Materials of Pittsfield, Mass. improve the resistance of the polyurethane foam to oxidative-type reactions, such as scorch resulting from high exothermic temperatures. Dyes and/or pigmented colors, such as blue, green, yellow, orange, red, purple, brown, black, white, or gray, may be used to create certain colors within the polyurethane foam based on customer requirements and to distinguish various grades of foam. For example, dyes such as X-3 (blue), X-15 (yellow), X-38 (orange), X-64 (red), and X-96 may be used in the formulation. Other formulation additives such as diethanol amine (DEOA), DP-1022, SP-238, GM-210, and GM-206 may also be used as foam stabilizers, cross-linkers, and chain extenders. The aforementioned additives may alternatively or additionally be present in the formulation. Of course, the foregoing additives are purely exemplary and it should be clearly understood that the formulation may include additives, other than those specifically disclosed herein, to improve these or other characteristics of the polyurethane foam and/or enhance one or more of the properties of the foam.

The physical properties of the polyurethane foam indicate whether the foam is a conventional, high resilience (HR), or viscoelastic foam. Conventional flexible slabstock polyurethane foam typically contains a majority of open cells and has greater air permeability characteristics than either HR or viscoelastic foam. In embodiments thereof, the conventional polyurethane foam has a density between about 0.1 pounds per cubic foot (pcf) and about 10 pcf, between about 0.5 pcf and about 5 pcf, or between about 0.8 pcf and about 3.5 pcf. The firmness of the polyurethane foam is measured by its indentation force deflection (IFD). Although the firmness of the polyurethane foam is generally measured as 25 percent IFD, the firmness may be measured in other IFD amounts, such as 65 percent IFD. In embodiments thereof, the conventional polyurethane foam embodiment has an IFD between about 1 pound and about 200 pounds, between about 3 pounds and about 100 pounds, or between about 5 pounds and about 50 pounds. Finally, in embodiments thereof, the conventional polyurethane foam may have an index between about 60 and about 150, between about 80 and about 130 or between about 95 and about 120.

In contrast, HR foam is differentiated from conventional polyurethane foam by increased amounts of closed cells within the foam, higher comfort or support factor and higher resilience. In one embodiment, HR foam has a ball rebound value of greater than about 60 percent. The lower resilience, conventional polyurethane foam typically has a ball rebound value of less than about 55 percent and often below about 50 percent. In embodiments thereof, the HR foam embodiment has a density between about 0.9 pcf and about 12 pcf, between about 1.4 pcf and about 7 pcf, or between about 1.8 pcf and about 3.5 pcf. In embodiments thereof, the HR polyurethane foam embodiment has an IFD between about 5 pounds and about 70 pounds, between about 10 pounds and about 50 pounds, or between about 20 pounds and about 40 pounds. Finally, the HR polyurethane foam embodiment has an index between about 60 and about 150, between about 80 and about 130 or between about 100 and about 115.

In that it has both viscous and elastic properties, viscoelastic polyurethane foam is differentiated from both conventional and HR polyurethane foams. Due to its relatively long recovery time after the removal of a compressive force, viscoelastic polyurethane foam is also known as memory foam. In embodiments thereof, the viscoelastic polyurethane foam has a density between about I pcf and about 10 pcf, between about 2 pcf and about 6 pcf or between about 3 pcf and about 5 pcf. In further embodiments thereof, the viscoelastic polyurethane foam has an IFD between about 1 pound and about 30 pounds, between about 3 pounds and about 20 pounds or between about 5 pounds and about 13 pounds. Finally, in still further embodiments thereof, the viscoelastic polyurethane foam has an index between about 20 and about 130, between about 50 and about 80 or between about 65 and about 75.

The polyol, isocyanate and strut reinforcing agent, as well as any other formulation components, for example, the aforementioned blowing agents, catalysts, surfactants, foam processing aids and/or additives, are mixed together such that the resultant reaction produces the polyurethane foam. In one embodiment, this process involves mixing the strut reinforcing agent with a conventional, graft, HR graft, or other specialty polyol such that the resultant solution contains between about 10 percent and about 20 percent of the strut reinforcing agent. The mixture is then pumped, together with the other component streams, to a high-speed mixer where all of the components are mixed together to form a homogenous solution. The resultant homogenous solution is dispensed into a pouring trough that empties onto fall plates of a pouring line where, while being transported by a moving conveyor, the mixture undergoes a gelling and blowing reaction which continues until the resultant polyurethane foam reaches its maximum rise and blow-off point.

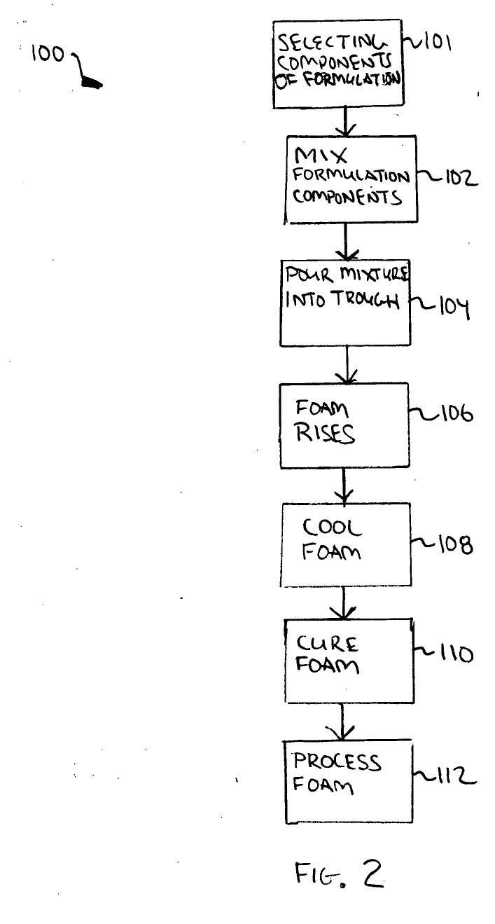

Referring next to FIG. 2, a method 100 for producing a strut-reinforced polyurethane foam will now be described in greater detail. As may now be seen, the method 100 generally comprises selecting the formulation components at 101, mixing the selected formulation components at 102, pouring the mixture into a trough at 104, allowing the reacting polymer to rise and form the strut-reinforced polyurethane foam at 106, cooling the strut-reinforced polyurethane foam at 108, curing the strut-reinforced polyurethane foam at 110 and processing the strut-reinforced polyurethane foam at 112. Of course, as the foregoing is a broad description of the method 100, further details of the method 100 are set forth hereinbelow.

More specifically, the method 100 of producing a strut-reinforced polyurethane foam begins at 101 by selecting both the type and amount of each of the components of the formulation to be used to produce the strut-reinforced polyurethane foam. In its broadest sense, the components of the formulation include a polyol, an isocyanate and a strut reinforcing agent. More commonly, the components of the formulation include a polyol, an isocyanate, a strut reinforcing agent, a blowing agent and a catalyst. If desired, the components of the formulation may further include surfactants, foam processing aids, flame retardants, antimicrobials, antioxidants, pigments, dyes, cross-linkers, stabilizers and/or chain extenders.

Upon selecting the type and amount of each component of the formulation, the method 100 proceeds to 102 where the selected amounts of each of the selected components are mixed together. Typically, each component of the formulation is stored in an individual tank or other suitable storage facility and piped, pumped, metered or otherwise transported to a mixer. It is contemplated that a positive displacement metering pump is a suitable device to transport most of the components of the formulation to the mixer. It should be noted, however, that positive displacement metering pumps should not be employed to transport the blowing agent and the polyol to the mixer if the blowing agent selected for the formulation is carbon dioxide. In this regard, it is noted that, as it is generally preferred to keep the carbon dioxide dissolved in the high pressure stream of polyol fed to the mixer until the mixture of the blowing agent, polyol and other components of the formulation is poured into the trough at 104, it is oftentimes necessary to keep the carbon dioxide and/or polyol at appropriately low temperatures/appropriately high pressures to ensure that the carbon dioxide remains dissolved in the high pressure polyol stream until after the mixing operation is complete. Accordingly, when carbon dioxide is used as the blowing agent, it is preferred that the devices employed for the respective transport of the carbon dioxide blowing agent and polyol to the mixer be capable of maintain the proper conditions to accomplish the foregoing objective.

Upon the formulation components being transported to the mixer, the method 100 proceeds to 102 where the formulation components are mixer may be a static mixer comprised of a plurality of baffles or a dynamic mixer comprised of a plurality of moving agitators. As the components of the formulation are mixed together, the components being to react with one another, thereby commencing the production of foam. Of course, the foregoing transport techniques are purely exemplary and it should be clearly understood that the transport of the selected components to the mixer may be accomplished by a wide variety of transport techniques and/or transport devices other than those specifically recited herein. Similarly, the foregoing mixing techniques are also purely exemplary and it should also be clearly understood that the mixing of the formulation components may be accomplished by a wide variety of mixing techniques and/or mixing devices other than those specifically recited herein.

Production of the foam continues at 104 where the, now-reacting, mixture produced at 102 is poured into a trough. Variously, the mixture may poured into the trough through a snorkel forming part of a head portion of the mixer. In the alternative, the mixture may be directed to the trough using a gate bar or letdown device. If a gate bar or letdown device is employed, it is contemplated that Cannon-Viking gate bar between about 1.8 and about 2 meters wide and equipped with a shim capable of varying the exit velocity and pressure of the reacting foam as the pressure decreases to atmospheric pressure during the release of the foam onto the fall plates. Once the solution of carbon dioxide (or other blowing agent), polyol and the other components of the selected formulation exit the gate bar, the aforementioned decrease in pressure enables the carbon dioxide to expand and cool the polyurethane foam continuing to be formed by the reaction of the components of the selected formulation. Of course, the foregoing pouring techniques are purely exemplary and it should be clearly understood that pouring of the mixed formulation into the trough may be accomplished by a wide variety of mixing techniques other than those specifically recited herein.

The method 100 of producing the polyurethane foam continues at 106 where the polyurethane foam poured into the trough begins to rise. After the polyurethane foam expands within the trough, it spills over the upper lip of the fall plate, also referred to as a pour plate, and travels down the length of the fall plate. As the polyurethane foam travels down the fall plate, the gelling and blowing reactions continue to occur within the polyurethane foam such that the polyurethane foam is simultaneously falling down the fall plate and rising due to the blowing reaction. The simultaneous rising and falling of the polyurethane foam generally gives the top of the polyurethane foam a level appearance which extends from the trough to the end of the fall plate. In some embodiments, the polyurethane foam may appear to have an inclination either towards the trough or away from the trough due to an imbalance between the change in thickness of the polyurethane foam and the change in height of the fall plate. After the polyurethane foam has traveled the length of the fall plate, the foam passes onto a moving conveyor and subsequently transported down a production line. As the foam travels along the production line, a knife, hot wire, saw or other suitable cutting apparatus separates the foam into a series of buns, each having a desired lengthwise dimension. For example, in one embodiment, a desired lengthwise dimension would be 60 feet. Of course, the foregoing rising techniques are purely exemplary and it should be clearly understood that the rising of the polyurethane foam may be accomplished by a wide variety of rising techniques and/or devices other than those specifically recited herein. Similarly, the foregoing cutting techniques are also purely exemplary and it should also be clearly understood that cutting of the foam may be accomplished by a wide variety of cutting techniques and/or cutting devices other than those specifically recited herein.

The method 100 of producing a strut-reinforced polyurethane foam continues with cooling of the foam at 108 and curing of the foam at 110. In this regard, it should be noted that the cooling and curing processes are often times referenced in combination with one another as cooling of the foam typically occurs while the foam cures. As will be more fully described below, the cooling/curing of the polyurethane foam typically includes a process commonly referred to as “vacuum force curing.” It should be noted, however, that the vacuum force curing process is not commenced for at least about 30 minutes after the aforementioned reaction process for the formulation commences, thereby allowing for most of the reaction process to complete. Of course, to lessen the risk of potentially dangerous exothermic temperatures being generated, those formulations characterized by higher exothermic reactions typically require additional reaction time before initiating the aforementioned vacuum force curing process.

After the reaction and cutting processes are complete, the strut-reinforced polyurethane foam is transported to a vacuum table. At this point in the method 100, the foam has typically cooled to a temperature between about 200° F., and about 350° F., and, more commonly, between about 250° F., and about 325° F., and a skin has formed on the surfaces of the foam. As the skin tends to interfere with cooling of the foam, it is desirable to remove the skin so that air may pass through the foam, thereby enhancing cooling of the foam during the vacuum force curing process. When the foam is positioned over the vacuum table, a vacuum source is applied to a bottom side surface of the foam, thereby drawing ambient air into the foam through top and side surfaces thereof of the foam and out through the bottom of the foam. In addition to cooling the foam, the flow of ambient air through the foam produced by the vacuum source causes may forcibly draw VOCs out of the foam and into an exhaust stream produced by the vacuum source. As will be more fully described below, the exhaust stream is directed through a pre-filter and scrubber to remove any VOCs drawn out of the foam. The foam will remain on the vacuum table until it has cooled to a temperature between about 100° F., and about 160° F. The foam is then transported to a curing, or “bun storage”, area for further processing.

If a foam characterized by a low or otherwise poor airflow flow, for example, a viscoelastic foam or a closed cell HR foam, it may be advantageous to omit use of the aforedescribed vacuum table to cool and vacuum force cure the foam. For example, the low airflow properties of certain foams may result in the foam becoming permanently flattened during the vacuum forced curing process. In addition, low airflow foams are typically produced from formulations characterized by a low exothermic reaction posing little or no risk of spontaneous combustion due to the high temperatures which tend to result from an excessively high exothermic reaction. For the foregoing reasons, foams with low or otherwise poor air flow characteristics, as well as those foams produced by reactions which tend not to generate substantial amounts of heat may not require forced vacuum curing of the foam.

After vacuum force cooling/curing of the strut-reinforced polyurethane foam is completed, the foam is allowed to further cure an additional amount of time, typically, between about 24 and about 48 hours, until it reaches ambient temperature. In those embodiments where, as previously set forth, the strut-reinforced polyurethane foam does not require vacuum force cooling/curing, the foam is allowed to cure for a period of time between about 48 and about 72 hours. At this point, any remaining reactions are complete and the foam has cooled to ambient temperature. Of course, the foregoing cooling and/or curing techniques are purely exemplary and it should be clearly understood that cooling and/or curing of the polyurethane foam may be accomplished by a wide variety of cooling and/or curing techniques and/or devices other than those specifically recited herein.

If desired, the process 100 of producing a strut reinforced polyurethane foam continues on to 112 for further processing. More specifically, at 112, the foam may remain in bun form or, in the alternative, be processed into a variety of foam products using any number of post-formation foam processing techniques. In one embodiment, the foam is sliced into layers of a predetermined thickness, such a one-half inch, one inch, or two inches. Slices of foam having the foregoing thicknesses would be particularly useful in a variety of applications, including, but not limited to, flooring underlayment, mattress components, furniture components, insulating materials and the like. In alternative embodiments, a variety of shapes may be cut out of the foam (or sliced layers of the foam), for example, using a die or other cutting device. In one embodiment, a laser may be used to cut shapes out of the foam or sliced layers of the foam. Generally, lasers are particularly useful relatively complex shapes are to be cut out of the foam or sliced layers thereof. In further alternative embodiments, a convoluting machine may be used to cut convoluted or other complex shapes out of the foam or a sliced layer of the foam. Of course, the foregoing foam processing techniques are purely exemplary and it should be clearly understood that processing of the polyurethane foam may be accomplished by a wide variety of foam processing techniques and/or devices other than those specifically recited herein. Furthermore, while the only post-formation foam processing technique disclosed herein are cutting techniques, it is fully contemplated other types of post-formation foam processing techniques may be employed in place of or in conjunction with the disclosed cutting techniques.

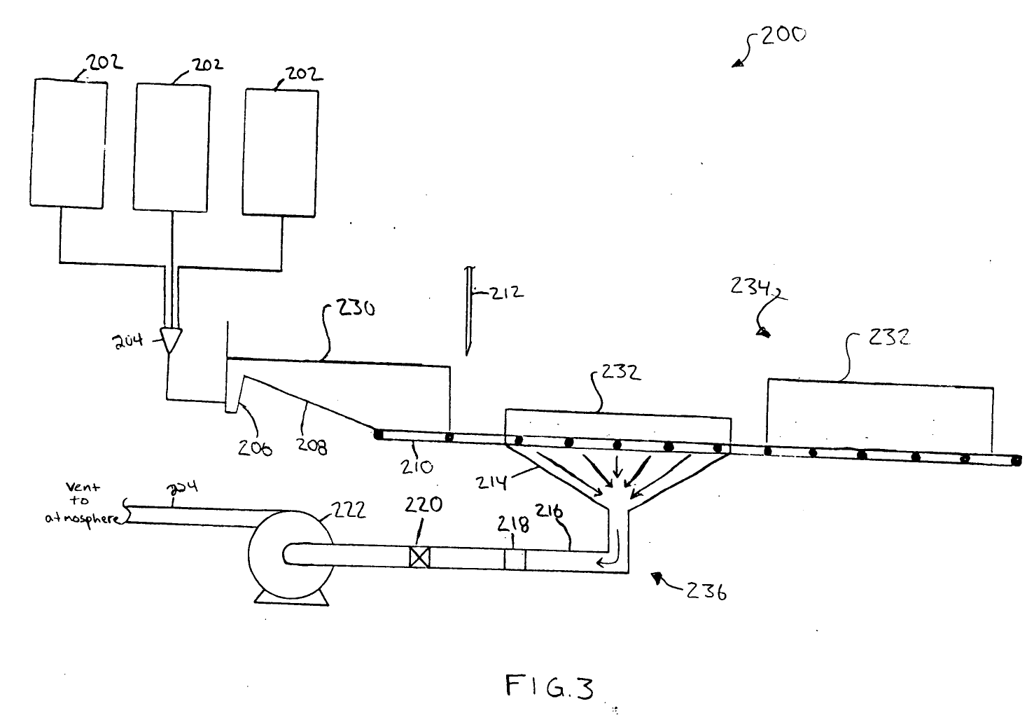

Referring next to FIG. 3, an apparatus, specifically, a foam production line 200 for manufacturing a strut-reinforced polyurethane foam in accordance with the method 100 of FIG. 3 will now be described in greater detail. As may now be seen, the foam production line 200 includes a plurality of storage tanks 202, a mixer 204, a trough 206, a fall plate 208, a conveyer 210, a knife 212, a vacuum table 214, exhaust piping 216, a pre-filter 218, a scrubber 220, a vacuum pump 222, and vent piping 224. Production of the strut-reinforced polyurethane foam 230 begins when plural components of the foam flow from the storage tanks 202, to the mixer 204. Although only three storage tanks 202 are depicted in FIG.3, the foam production line 200 may be configured with any number of storage tanks 202 and generally contains one storage tank 202 for each component of the formulation. If desired, one or more pumps may be installed in the piping between the storage tanks 202 and the mixer 204 to facilitate transportation of the formulation components to the mixer 204. The mixer 204 then mixes the formulation components together. Variously, the mixer 204 may be a static mixer comprising a plurality of baffles within the pipes or a dynamic mixer comprising a plurality of moving agitators.

After the components are mixed together by the mixer 204, the mixture is poured into the trough 206. If desired, one or more pumps may be installed in the piping between the mixer 204 and the trough 206 to facilitate transportation of the mixture to the trough 206. Alternatively, a gravity feed may be used to transport the mixture of components of the foam to the trough 206.

Once the mixture is deposited in the trough 206, gelling and blowing reactions begin to form the strut-reinforced polyurethane foam. The foam rises out of the trough 206 and spills over onto the fall plate 208, continuing to rise as it progresses down the fall plate 208. Upon completing traversal of the fall plate 208, the foam is deposited onto the conveyor 210. The foam 230 travels along the conveyor 210 towards the knife 212. Preferably, the knife 212 is positioned relative to the conveyor 210 such that the foam 230 is cut into sections, each having a desired length. For example, the knife 212 may be positioned relative to the conveyor 210 such that the foam 230 is cut into plural sections, each having a length of approximately 60 feet. Of course, sectioning of the foam 230 is optional and, if desired, the foam 230 may be transported along the conveyor 210 without any sectioning thereof

Once cut into sections of a predetermined desired length, sections 232 of the strut-reinforced polyurethane foam are transported along the conveyor 210 to the vacuum table 214 where a flow of air through the sections 232 cools the foam. As previously set forth, as cooling and curing of the foam typically occur in conjunction with one another, the cooling of the sections 232 at the vacuum table 214 also cures the sheet 232 of foam. More specifically, the vacuum pump 222 draws air, typically, air at ambient (or room) temperature, through the section 232 of foam, into the vacuum table 214 and through the exhaust piping 216, the pre-filter 218, and the scrubber 220. The air then passes through the vacuum pump 222 and out the vent piping 224 where it is vented to the atmosphere. Depending on both the strength of the vacuum applied to a bottom side surface of the sections 232 and structural characteristics of the foam from which the sections 232 are formed, application of a vacuum to a bottom side surface thereof may result in the section being pulled into a compressed state such as that illustrated in FIG. 3.

After being cooled, the sections 232 of the foam are removed from the vacuum table 214 and transported, for example by crane, to an area for curing and further processing (shown, generally, in FIG. 3, as further processing area 234.). Removal of the vacuum applied by the vacuum table 214 will, as also shown in FIG. 3, typically allow the sections 232 of foam to return to their original height. As previously set forth, however, depending on certain characteristics of the foam, the sections 232 may be crushed during application of the vacuum and be unable to return to its original height.

If desired, a fume hood (not shown) may be installed over the trough 206, the fall plate 208 and all (or part) of the conveyor 210 such that any vapors and/or fumes released from the foam 230 and/or section 232 of the foam during its production are captured within the fume hood. Of course, if only part of the conveyor 210 is covered by the fume hood, preferably, the covered portion would include the vacuum table 214. If configured to include a fume hood, it is contemplated that the flow of air into an air intake side of the fume hood would draw the fumes and/or vapors generated during the production of the foam into the hood. Within the fume hood, a filter system incorporated thereinto removes air-borne particles and the like before exhausting the filtered air back to the facility from which the air was withdrawn. While the filtering process performed by the fume hood is relatively rudimentary when compared to the exhaust system 236 used to removes VOCs extracted from the sections 232 of the foam, it is contemplated that the demands placed on the fume hood would be significantly less than those placed on the exhaust system 236. To improve air quality within the facility in which the foam processing line 200 is housed, it may be desirable to exhaust the fumes and/or vapors drawn into the fume hood. If so, the fume hood may be provided with its own exhaust system or, more preferably, the exhaust system of the fume hood may be coupled to the exhaust system 236. If so, the exhaust system of the fume hood should be coupled to the exhaust system 236 upstream of the pre-filter 218. By doing so, the exhaust stream generated by the fume hood would pass through the pre-filter 218 and the scrubber 220 before being vented to the atmosphere.

As foam production facilities are typically monitored to determine the amount of VOCs emitted into the atmosphere thereby, foam production lines are typically configured to reduce the level of VOCs emitted thereby. For example, the foam production line 200 incorporate the pre-filter 218 and the scrubber 220, both of which reduce the level of VOCs contained in the exhaust stream vented to the atmosphere. As previously set forth, vacuum pressure produced by the vacuum table 214 draws ambient air through the sections 232 of the foam 230. As the ambient air passes through the interior of the sections 232 of the foam 230, the flow of air removes VOCs from the sections 232 of the foam 230. The VOCs removed from the sections 232 of the foam 230 include, among others, unused reactants from the gelling and/or blowing reactions, carbon dioxide, stabilizers, antioxidants, inert blowing agents, fluorocarbons, CFCs, methylene chloride, acetone, trichloroethane, BHT, trace impurities from the raw materials and other byproducts. Moreover, the exhaust stream can also include solid particulate matter drawn from the freshly produced foam and small pieces of foam that are vacuumed off of the foam 230. Although not harmful to the environment, the small pieces of foam are a nuisance and maintenance problem if discharged into the atmosphere. Thus, the solid portions of the exhaust stream are removed by the pre-filter 218, an open cell polyurethane foam capable of allowing a flow of air therethrough. In the alternative, it is contemplated that effective filtering of foam debris can also be accomplished using a woven or nonwoven fiber batt, a metal mesh, fiberglass, or other porous filter that will produce a minimum back pressure, or pressure drop, across the pre-filter 218. The remaining undesirable substances in the exhaust stream, including the VOCs removed from the sections 232 of the foam 230, are removed by the scrubber 220. The scrubber 220 is comprised of a bed of specialized activated carbon char that is specifically designed to adsorb the VOCs in the exhaust stream.

In one embodiment, the strut-reinforced polyurethane foam may be produced using a molded foam process. Briefly, in a molded foam process, the foam-producing formulation described hereinabove is injected into an enclosed mold. As before, the gelling and blowing reactions would subsequently occur. Here, however, as the formulation has been injected into an enclosed mold, the resultant foam would take the shape of the mold. After the foam rises, the foam is removed from the mold and the process repeated. Molded foam production processes are typically utilized when forming smaller foam products. Of course, the foregoing molded foam production technique is purely exemplary and it should be clearly understood that forming a molded polyurethane product may be accomplished by a wide variety of molding techniques other than those specifically recited herein.

It is further contemplated that the process conditions under which the strut-reinforced polyurethane foam is produced may be varied to produce any number of different types of polyurethane foam. In this regard, it is noted that by varying the temperature, pressure or other physical conditions under which polyurethane foam is produced will change the physical characteristics of the foam. For example, in one embodiment, the foam processing line 208 may be enclosed in a chamber or, in the alternative, substantially surrounded by heating and/or cooling devices that enable the temperature of the foam processing line 200 to be increased or decreased to a specified temperature such that the foam 230 may be poured into the trough 206 at temperatures greater or less than the ambient temperature for the foam processing line 200. In another, the foam processing line 200 may be enclosed in a chamber capable of maintaining a pressure or a vacuum, thereby enabling the pressure of the foam processing line 200 to be increased or decreased to a specified pressure so that the foam 230 may be poured into the trough 206 at pressures greater or less than the ambient pressure for the foam processing line 200. Of course, the foregoing processing conditions which may be modified to vary the characteristics of the strut-reinforced polyurethane foam are purely exemplary and it should be clearly understood that process conditions other than those specifically recited herein may be modified to vary the characteristics of the strut-reinforced polyurethane foam produced thereby.

Thusfar, the foam production techniques disclosed herein have been directed to the formation of strut-reinforced polyurethane foam. It is fully contemplated, however, that the foam production techniques disclosed herein may also be used to produce strut-reinforced foams other than the disclosed strut-reinforced polyurethane foam disclosed herein. To do so would require the incorporation of the disclosed strut-reinforcing into formulations used to produce other types of foam. Examples of other types of foam suitable for inclusion of the disclosed strut-reinforcing agents include polyvinylchloride (PVC) foam, polystyrene foam and other types of polymer foams. Of course, the foregoing other types of strut-reinforced foam which may produced by application of the techniques disclosed herein are purely exemplary and it should be clearly understood that types of strut-reinforced foam other than the types of strut-reinforced foam specifically recited herein may be produced by application of the techniques disclosed herein.

The foam may be used for a variety of other applications. For example, the foam can also be used in a mattress as either a supporting layer within the mattress or as the comfort layer in a pillow-top layer of the mattress. In another application, the foam can be used in an article of furniture, for example, a chair. In still another, the foam may be used in a pillow for use in connection with a bed or other type of article of furniture. The foam may also be used to make insoles or inserts for shoes. In any of the foregoing applications, the use of the strut-reinforced foam is advantageous because the foam provides cushioning for a person to be supported by the mattress, chair or other article of furniture. Of course, the foregoing applications of the strut-reinforced foam are purely exemplary and it should be clearly understood that the disclosed strut-reinforced foam is suitable for use in connection with a wide variety of applications other than those specifically recited herein.

### EXAMPLE ONE

In one embodiment, a strut-reinforced foam was prepared using the formulation set forth below in Table I.

TABLE 1

| Component | Example | Amount (pph) |
|---|---|---|
| Polyol | VORANOL 3136 or 3137A | 100 |
| Isocyanate | T-80 | 39.39 |
| Strut Reinforcing Agent | 500N | 2 |
| Blowing Agent | Carbon Dioxide | 4.5 |
| Blowing Agent | Water | 2.99 |
| Surfactant | L-635 | 1.5 |
| Catalyst | A-33 | 0.285 |
| Catalyst | ZF-10 | 0.045 |
| Catalyst | TCAT 110 | 0.143 |
| Foam Processing Aid | GM-210 | 1.9 |
| FR Agent | FM-552 | 11 |
| Dye | X-15/X-96 | 0.05 |

The formulation in Table 1 was determined to have an isocyanate index of about 103 and produced acceptable strut-reinforced foam with an IFD between about 7 pounds and about 12 pounds and a density between about 1.2 pcf and about 1.3 pcf.

### EXAMPLE TWO

In another embodiment, a strut-reinforced foam was produced using the formulation set forth below in Table 2.

TABLE 2

| Component | Example | Amount (pph) |
|---|---|---|
| Polyol | VORANOL 3136 or 3137A | 100 |
| Isocyanate | T-80 | 52.31 |
| Strut Reinforcing Agent | 500N | 2.5 |
| Blowing Agent | Carbon Dioxide | 3.2 |
| Blowing Agent | Water | 3.84 |
| Surfactant | L-635 | 1.5 |
| Catalyst | A-33 | 0.08 |
| Catalyst | ZF-10 | 0.03 |
| Catalyst | TCAT 110 | 0.179 |
| FR Agent | FM-552 | 14 |
| Dye | X-15/X-96 | 0.056 |

The formulation in Table 2 was determined to have an isocyanate index of about 114 and produced acceptable strut-reinforced foam with an IFD between about 20 pounds and about 24 pounds and a density between about 1.2 pcf and about 1.3 pcf.

### EXAMPLE THREE

In another embodiment, a strut-reinforced foam was prepared using the formulation set forth below in Table 3.

TABLE 3

| Component | Example | Amount (pph) |
|---|---|---|
| Polyol | VORANOL 3136 or 3137A | 100 |
| Isocyanate | T-80 | 52.13 |
| Strut Reinforcing Agent | 500N | 2.5 |
| Blowing Agent | Carbon Dioxide | 3.2 |
| Blowing Agent | Water | 3.84 |
| Surfactant | L-635 | 1.5 |
| Catalyst | A-133 | 0.08 |
| Catalyst | ZF-10 | 0.03 |
| Catalyst | TCAT 110 | 0.179 |
| FR Agent | FM-552 | 14 |
| Dye | X-15/X-96 | 0.056 |

The formulation in Table 3 was determined to have an isocyanate index of about 114 and produced acceptable strut-reinforced foam with an IFD of about 27.5 pounds, a density of about 1.35 pcf, and an air permeability of about 5 cfm.

### EXAMPLE FOUR

In addition to variations in the amount of components include in the formulation, strut-reinforced foams have been produced under varied process conditions, specifically, variations in relative humidity during formation of the foam. In the foregoing examples, the relative humidity in the atmosphere is generally expressed as grains of moisture. In this example, the formulations presented herein required adjustment to account for the relative humidity under which the process was conducted.

Accordingly, in this embodiment, strut-reinforcing foam was prepared using the formulations and under the process conditions set forth below in Table 4.

TABLE 4

| | | Formulation A | Formulation B | Formulation C |
|---|---|---|---|---|
| Component | Example | Amount (pph) | Amount (pph) | Amount (pph) |
| Polyol | VORANOL 3136 | 100 | 100 | 100 |
| | or 3137A | | | |
| Isocyanate | T-80 | 52.71 | 52.52 | 55.79 |
| Strut Reinforcing | 500N | 3 | 3 | 3 |
| Agent | | | | |
| Blowing Agent | Water | 3.95 | 4 | 4.1 |
| Surfactant | L-618 or L-650 | 1 | 1 | 1 |
| Catalyst | A-33 | 0.05 | 0.07 | 0.072 |
| Catalyst | ZF-10 | 0.06 | 0.08 | 0.077 |
| Catalyst | TCAT 110 | 0.232 | 0.29 | 0.34 |
| | or K-29 | | | |
| Foam Processing | GM-206 or | 2.1 | 2.1 | 2.1 |
| Aid | SP-370 | | | |
| FR Agent | FM-552 | 12 | 12 | 12 |
| Dye | X-15/X-38 | 0.043 | 0.043 | 0.043 |

Formulation A was run under process conditions which included a relative humidity of 43 grains of moisture. The formulation was determined to have an isocyanate index of about 100 and produced acceptable strut-reinforced foam with an IFD of about 25.6 pounds, a density of about 1.53 pcf, and an air permeability of about 4.5 cfm.

Formulation B was run under process conditions which included a relative humidity of 37 grains of moisture. The formulation was determined to have an isocyanate index of about 100 and produced acceptable strut-reinforced foam with an IFD of about 23.1 pounds, a density of about 1.52 pcf, and air permeability of about 5.5 cfm.

Formulation C was run under process conditions which included a relative humidity of 44 grains of moisture. The formulation was determined to have an isocyanate index of about 100.75 and produced acceptable strut-reinforced foam having an IFD between about 23 pounds and about 27 pounds and a density of between about 1.4 pcf and about 1.5 pcf.

### EXAMPLE FIVE

In further embodiments, a strut-reinforced foam was produced using the formulations set forth below in Table 5A.

TABLE 5A

| | | Formulation A | Formulation B | Formulation C | Formulation D |
|---|---|---|---|---|---|
| | | Amount | Amount | Amount | Amount |
| Component | Example | (pph) | (pph) | (pph) | (pph) |
| Polyol | VORANOL | 100 | 100 | 100 | 100 |
| | 3136 or 3137A | | | | |
| Isocyanate | T-80 | 46.1 | 45.17 | 47.96 | 53.75 |
| Strut | 500N | 4 | 4 | 4 | 4 |
| Reinforcing | | | | | |
| Agent | | | | | |
| Blowing | Water | 3.5 | 3.5 | 3.4 | 3.6 |
| Agent | | | | | |
| Surfactant | L-618 or L-650 | 0.9 | 0.9 | 0.9 | 0.9 |
| Catalyst | A-33 | 0 | 0.05 | 0.05 | 0.05 |
| Catalyst | ZF-10 | 0.06 | 0.06 | 0.06 | 0.06 |
| Catalyst | TCAT 110 | 0.22 | 0.242 | 0.204 | 0.197 |
| Foam | GM-206 or | 1.3 | 1.3 | 1.8 | 2 |
| Processing | SP-370 | | | | |
| Aid | | | | | |
| FR Agent | FM-552 | 10 | 10 | 10 | 11 |
| Dye | X-15/X-38 | 0.045 | 0.007 | 0.007 | 0.043 |

Formulation A was run under process conditions which included a relative humidity of 46 grains of moisture. The formulation was determined to have an isocyanate index of about 103 and produced acceptable strut-reinforced foam having an IFD of about 28 pounds and a density of about 1.75 pcf

Formulation B was run under process conditions which included a relative humidity of 33 grains of moisture. The formulation was determined to have an isocyanate index of about 97 and produced acceptable strut-reinforced foam having an IFD of about 28.8 pounds, a density of about 1.65 pcf, and an air permeability of about 4.5 cfm.

Formulation C was determined to have an isocyanate index of about 102 and produced acceptable strut-reinforced foam having an IFD of about 29.2 pounds, a density of about 1.65 pcf and an air permeability of about 5.5 cfm.

Formulation D was run under process conditions which included a relative humidity of 114 grains of moisture. The formulation was determined to an isocyanate index of about 109 and produced acceptable strut-reinforced foam having an IFD between about 25 pounds and about 29 pounds and a density between about 1.6 pcf and about 1.7 pcf.

The fatigue resistance of the strut-reinforced foam was tested and subsequently compared to two other foams with similar firmness and density. More specifically, the strut-reinforced foam produced using Formulation C of Example Five was compared to (a) a conventional foam having an ICD of about 27 pounds and a density of about 1.7 pcf and (b) a similar conventional foam produced in accordance with the process described and illustrated in U.S. Pat. No. 6,716,890 and marketed under the trade name REFLEX CORE® by Foamex International, Inc. of Linwood, Pa. Samples of the three types of foams were tested using the procedure described in ASTM 3574-01 “Standard Method of Testing Cellular Materials —Slab, Bonded, and Molded Urethane Foam.” The three samples were tested for two properties: 65% IFD and thickness. Measurements of the initial thickness and the 65% IFD for each of the foam samples were taken using an automated AVATAR compression testing machine.

In the test, a plate having an 8 inch diameter applied a load at the general center of each foam sample at a rate of 2 inches per minute. The test was performed with a one pound per load. After recording the initial measurements, the cushions were subjected to cyclic loading at 170 pounds for 50,000 cycles at a rate of 35 cycles per minute with a 10-inch diameter indenter foot. The height and 65% IFD properties were measured 24 hours after fatiguing at the following intervals: 8,000 cycles, 10,000 cycles, 20,000 cycles, 30,000 cycles, 40,000 cycles, and 50,000 cycles.

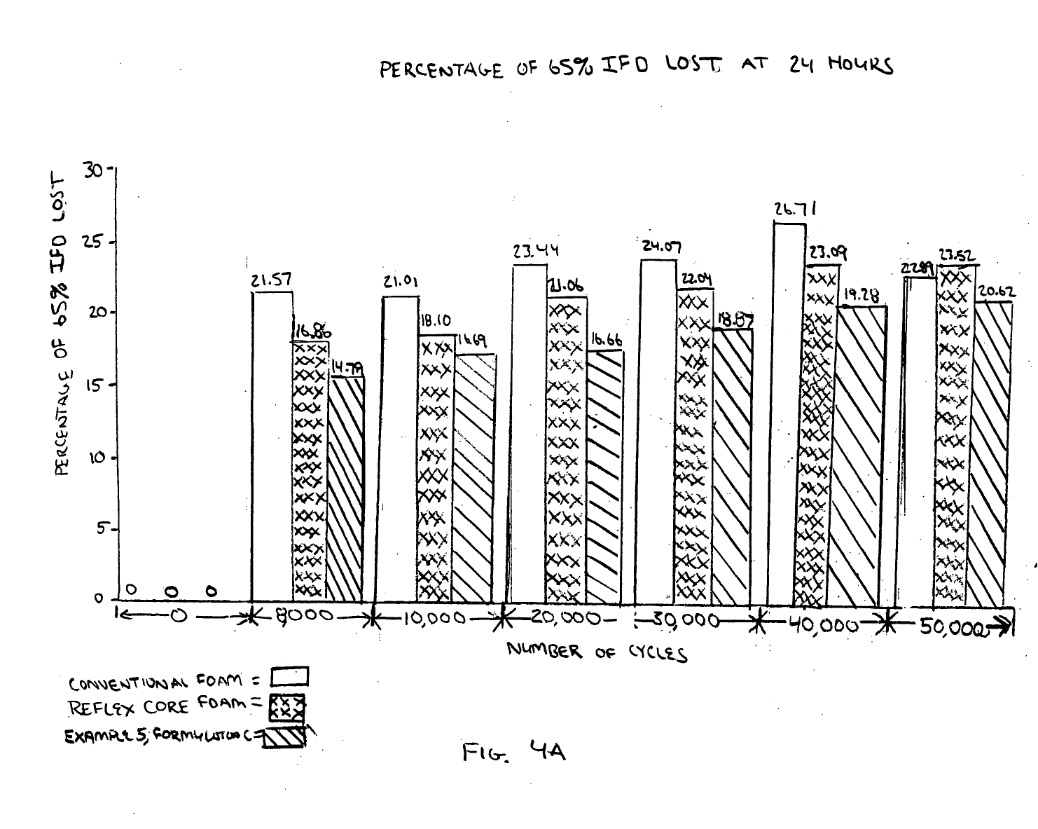

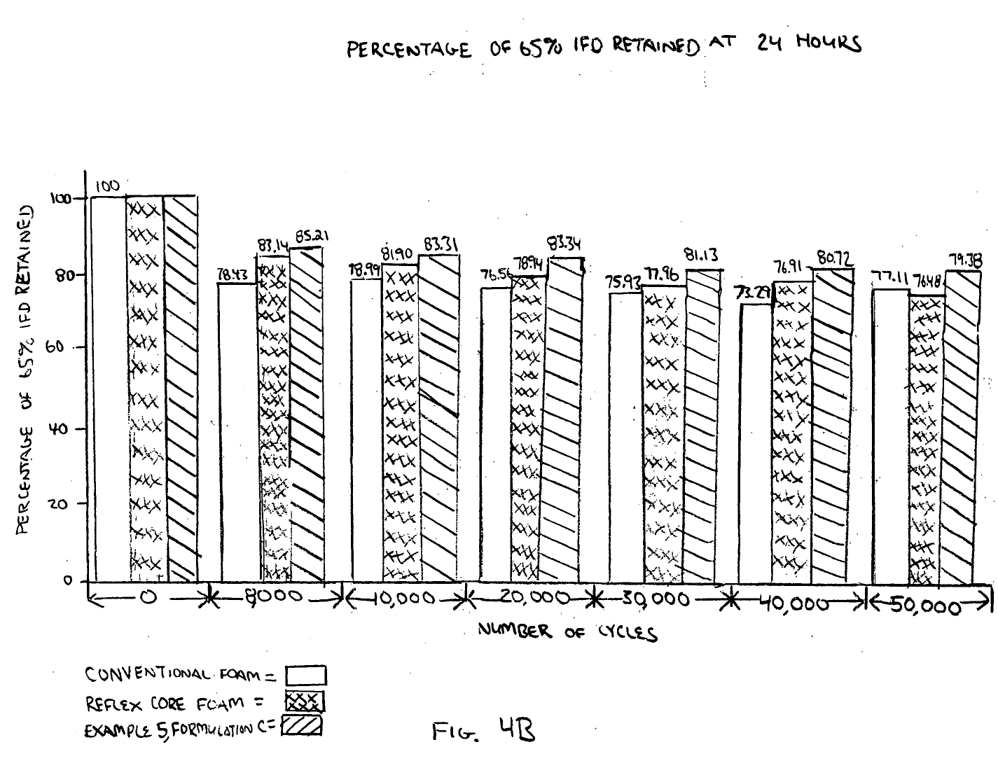

Table 5B sets forth the 65% IFD of the three samples recorded during the testing process. Table 5C sets forth the height of the three samples recorded during the testing process. Table 5D sets forth the percentage loss of the 65% IFD of the three samples recorded during the testing process. The percent loss of the 65% IFD set forth in Table 5D is graphically illustrated in FIG. 4A. Finally, Table 5E sets forth the percent retention of the 65% IFD of the three samples recorded during the testing process. The percent retention of the 65% IFD set forth in Table 5E is graphically illustrated in FIG. 4B.

TABLE 5B

| Cycles | | | | | | |
|---|---|---|---|---|---|---|
| 0 | 8,000 | 10,000 | 20,000 | 30,000 | 40,000 | 50,000 |

Fatigue Test - 30 Minutes After Fatiguing (65% IFD, pounds)

| | | | | | | | |
|---|---|---|---|---|---|---|---|
| Conventional Foam | 57.58 | 42.82 | 42.66 | 40.58 | 39.82 | 38.74 | 39.56 |
| Example 5, Formulation C | 69.62 | 57.28 | 57.46 | 55.84 | 54.84 | 54.38 | 54.24 |
| Reflex Core | 55.26 | 43.88 | 43.52 | 41.74 | 40.32 | 40.86 | 39.84 |

Fatigue Test - 24 Hours After Fatiguing (65% IFD, pounds)

| | | | | | | | |
|---|---|---|---|---|---|---|---|
| Conventional Foam | 57.58 | 45.16 | 45.48 | 44.08 | 43.72 | 42.2 | 44.4 |
| Example 5, Formulation C | 69.62 | 59.32 | 58 | 58.02 | 56.48 | 56.2 | 55.26 |
| Reflex Core | 55.26 | 45.94 | 45.26 | 43.62 | 43.08 | 42.5 | 42.26 |

TABLE 5C

| Cycles | | | | | | |
|---|---|---|---|---|---|---|
| 0 | 8,000 | 10,000 | 20,000 | 30,000 | 40,000 | 50,000 |

Fatigue Test - 30 Minutes After Fatiguing (Height)

| | | | | | | | |
|---|---|---|---|---|---|---|---|
| Conventional Foam | 3.982 | 3.905 | 3.911 | 3.904 | 3.879 | 3.86 | 3.878 |
| Example 5, Formulation C | 3.981 | 3.84 | 3.863 | 3.843 | 3.811 | 3.82 | 3.831 |
| Reflex Core | 3.978 | 3.932 | 3.94 | 3.927 | 3.885 | 3.917 | 3.916 |

Fatigue Test - 24 Hours After Fatiguing (Height)

| | | | | | | | |
|---|---|---|---|---|---|---|---|
| Conventional Foam | 3.982 | 3.963 | 3.966 | 3.965 | 3.955 | 3.952 | 3.946 |
| Example 5, Formulation C | 3.981 | 3.916 | 3.906 | 3.887 | 3.881 | 3.884 | 3.879 |
| Reflex Core | 3.978 | 3.967 | 3.961 | 3.951 | 3.955 | 3.949 | 3.945 |

TABLE 5D

| Cycles | | | | | | |
|---|---|---|---|---|---|---|
| 0 | 8,000 | 10,000 | 20,000 | 30,000 | 40,000 | 50,000 |

Fatigue Test - 30 Minutes After Fatiguing (Percent Loss of 65% IFD)

| | | | | | | | |
|---|---|---|---|---|---|---|---|
| Conventional Foam | 0 | 25.63 | 25.91 | 29.52 | 30.84 | 32.72 | 31.30 |
| Example 5, Formulation C | 0 | 17.72 | 17.47 | 19.79 | 21.23 | 21.89 | 22.09 |
| Reflex Core | 0 | 20.59 | 21.24 | 24.47 | 27.04 | 26.06 | 27.90 |

Fatigue Test - 24 Hours After Fatiguing (Percent Loss of 65% IFD)

| | | | | | | | |
|---|---|---|---|---|---|---|---|
| Conventional Foam | 0 | 21.57 | 21.01 | 23.44 | 24.07 | 26.71 | 22.89 |
| Example 5, Formulation C | 0 | 14.79 | 16.69 | 16.66 | 18.87 | 19.28 | 20.62 |
| Reflex Core | 0 | 16.86 | 18.10 | 21.06 | 22.04 | 23.09 | 23.52 |

TABLE 5E

| Cycles | | | | | | |
|---|---|---|---|---|---|---|
| 0 | 8,000 | 10,000 | 20,000 | 30,000 | 40,000 | 50,000 |

Fatigue Test - 30 Minutes After Fatiguing (Percent of Original 65% IFD)

| | | | | | | | |
|---|---|---|---|---|---|---|---|
| Conventional Foam | 100 | 74.37 | 74.09 | 70.48 | 69.16 | 67.28 | 68.70 |
| Example 5, Formulation C | 100 | 82.28 | 82.53 | 80.21 | 78.77 | 78.11 | 77.91 |
| Reflex Core | 100 | 79.41 | 78.76 | 75.53 | 72.96 | 73.94 | 72.10 |

Fatigue Test - 24 Hours After Fatiguing (Percent of Original 65% IFD)

| | | | | | | | |
|---|---|---|---|---|---|---|---|
| Conventional Foam | 100 | 78.43 | 78.99 | 76.56 | 75.93 | 73.29 | 77.11 |
| Example 5, Formulation C | 100 | 85.21 | 83.31 | 83.34 | 81.13 | 80.72 | 79.38 |
| Reflex Core | 100 | 83.14 | 81.90 | 78.94 | 77.96 | 76.91 | 76.48 |

As can be seen from an examination of Tables 5B-E and FIGS. 4A-B, the strut-reinforced foam produced from Formulation C of Example 5 is superior to both conventional foam and REFLEX CORE® foam. More specifically, testing consistently indicated that the strut-reinforced foam produced from formulation C has increased fatigue resistance when compared to conventional or REFLEX CORE® foam. As a result, when compared to conventional foam, the strut-reinforced foam produced from Formulation C of Example 5 will, over a period of time, retain more of its original firmness and height. Without being construed in a limiting sense, it is believed that the increased fatigue resistance of foam produced from Formulation C of Example 5 is due to a relocation of polymer material from the membranes and the partial membranes onto the struts of the foam which results from the inclusion of a strut-reinforcing agent in the formulation.

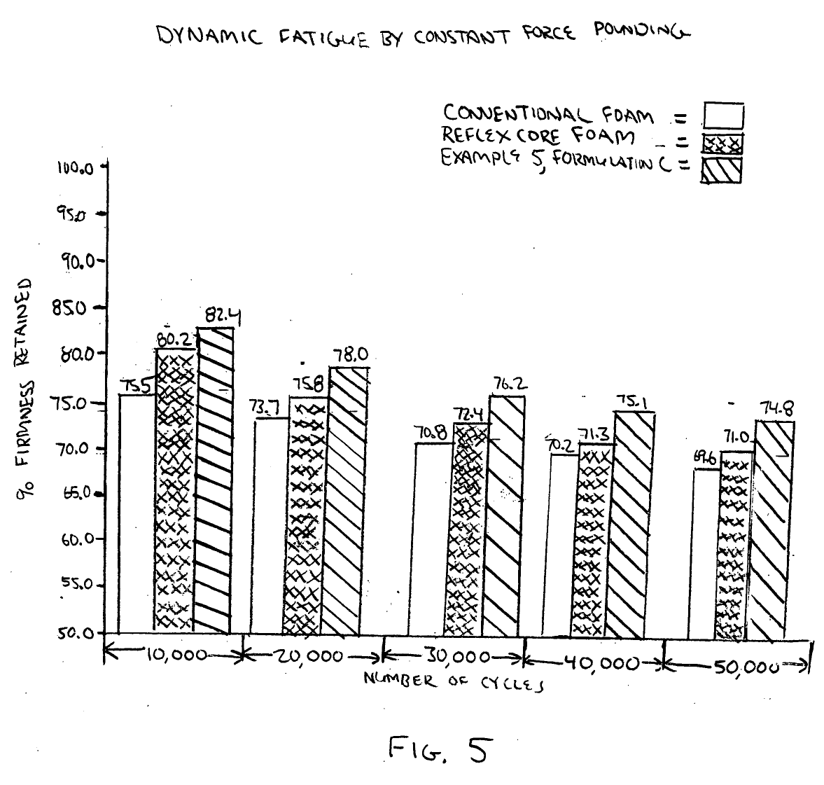

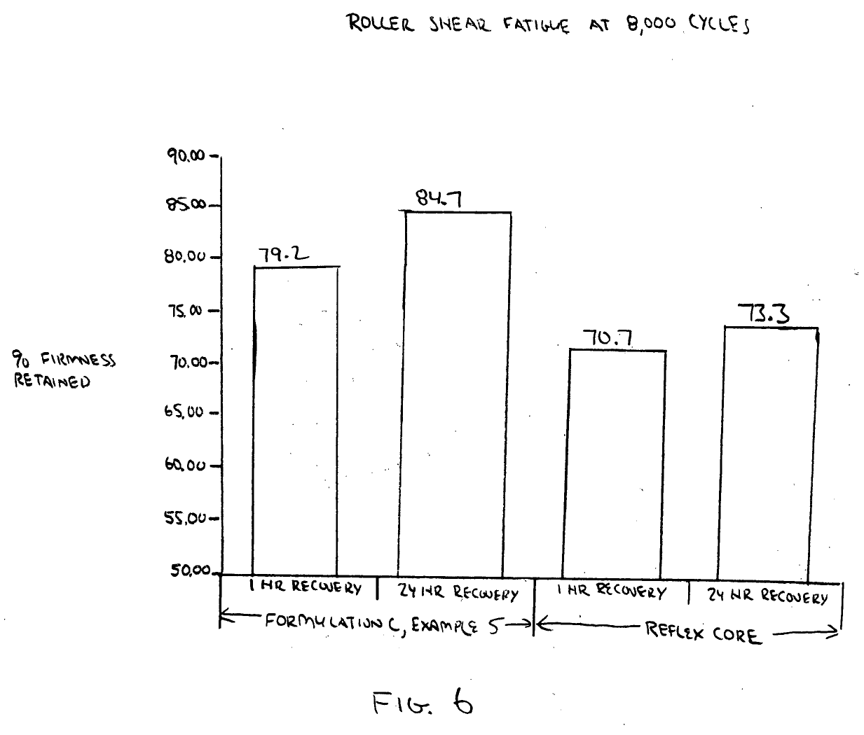

The pounding fatigue resistance and roller shear fatigue resistance of the strut-reinforced foam was also tested and subsequently compared to two other foams having similar physical characteristics. More specifically, the strut-reinforced foam produced using Formulation C of Example Five was compared to (a) a conventional polyurethane foam having an IFD of about 32 pounds and a density of about 1.8 pcf and (b) a similar conventional foam produced in accordance with the process described and illustrated in U.S. Pat. No. 6,716,890 and marketed under the trade name REFLEX CORE® by Foamex International, Inc. of Linwood, Pa. The pounding fatigue test was conducted on samples of the three foams in accordance with ASTM D 3574 Test 13, the Dynamic Fatigue Test by Constant Force Pounding. The rolling shear fatigue test was performed on only two foam products—the strut-reinforced foam produced using Formulation C of Example 5 and the REFLEX CORE® foam. The roller shear fatigue test was conducted in accordance with ASTM D 3574 Test I2, Procedure A, using 130 Newtons (29.2 pounds) constant force. The physical properties of the three foam products are illustrated in Table 5F. The results of the pounding fatigue test are shown in Table 5G and FIG. 5. The results of the roller shear fatigue test are shown in Table 5H and FIG. 6.

TABLE 5F

| | Example 5, | Reflex | Conventional |
|---|---|---|---|
| Property | Formulation C | Core | Foam |
| Density (pcf) | 1.67 | 1.61 | 1.78 |
| 25 Percent IFD (pounds) | 27.90 | 31.30 | 32.40 |
| Tensile Strength (pounds) | 16.00 | 15.21 | 15.80 |
| Tear Strength (pounds) | 2.40 | 1.82 | 2.40 |
| Support Factor | 2.10 | 1.90 | 1.91 |
| Percent Resilience (ball | 51.00 | 49.0 | 45.00 |
| rebound, inches) | | | |

TABLE 5G
Pounding Fatigue (Percent Firmness Retained)

| Cycles | Example 5, Formulation C | Reflex Core | Conventional Foam |
|---|---|---|---|
| 10,000 | 82.4 | 80.2 | 75.5 |
| 20,000 | 78.0 | 75.8 | 73.7 |
| 30,000 | 76.2 | 72.4 | 70.8 |
| 40,000 | 75.1 | 71.3 | 70.2 |
| 50,000 | 74.8 | 71.0 | 69.6 |

TABLE 5H
Roller Shear Fatigue (Percent Firmness Retained)

| | Example 5, | | | |
|---|---|---|---|---|
| | Formulation C | | Reflex Core | |
| | 1 Hour | | 1 Hour | |
| Cycles | Recovery | 24 Hrs. Recovery | Recovery | 24 Hrs. Recovery |
| 8,000 | 79.2 | 84.7 | 70.7 | 73.3 |

As can be seen from an examination of Tables 5F-H and FIGS. 5-6, the strut-reinforced polyurethane foam produced from Formulation C of Example 5 is superior to both conventional polyurethane foam and the REFLEX CORE® polyurethane foam. More specifically, testing consistently indicated that the strut-reinforced polyurethane foam produced from Formulation C of Example 5 is better able to retain more of its firmness when subjected to both pounding fatigue and roller shear tests. As a result, when compared to conventional polyurethane foams, the strut-reinforced polyurethane foam produced from Formulation C of Example 5 will, over a period of time, retain more of its original firmness. Without being construed in a limiting sense, it is believed that the increased fatigue resistance evidenced hereinabove is a direct result of a relocation of polymer material from the membranes and the partial membranes onto the struts of the polyurethane foam which results from the inclusion of a strut-reinforcing agent in the formulation.

### EXAMPLE SIX

In further embodiments thereof, strut-reinforced foams were produced using the formulations set forth below in Tables 6A, 6B, and 6C.

TABLE 6A

| | | Formulation A | Formulation B | Formulation C |
|---|---|---|---|---|
| Component | Example | Amount (pph) | Amount (pph) | Amount (pph) |
| Polyol | VORANOL 3136 | 100 | 100 | 100 |
| | or 3137A | | | |
| Isocyanate | T-80 | 54.13 | 55.43 | 54.88 |
| Strut Reinforcing | 500N | 3 | 3 | 3 |
| Agent | | | | |
| Blowing Agent | Water | 4 | 4.75 | 4.75 |
| Surfactant | L-618 or L-650 | 1 | 0.95 | 0.95 |
| Catalyst | A-33 | 0.074 | 0.05 | 0.05 |
| Catalyst | ZF-10 | 0.077 | 0.04 | 0.04 |
| Catalyst | TCAT 110 | 0.26 | 0.351 | 0.384 |
| Foam Processing | GM-210 | 2.1 | 0 | 0 |
| Aid | | | | |
| FR Agent | FM-552 | 11 | 11 | 11 |
| Dye | X-15/X-38 | 0.05 | 0.05 | 0.05 |

TABLE 6B

| | | Formulation D | Formulation E | Formulation F |
|---|---|---|---|---|
| Component | Example | Amount (pph) | Amount (pph) | Amount (pph) |
| Polyol | VORANOL 3136 | 100 | 100 | 100 |
| | or 3137A | | | |
| Isocyanate | T-80 | 54.26 | 53.99 | 54.48 |
| Strut Reinforcing | 500N | 3 | 3 | 3 |
| Agent | | | | |
| Blowing Agent | Water | 4.8 | 4.8 | 4.05 |
| Surfactant | L-618 or L-650 | 0.95 | 0.95 | 1 |
| Catalyst | A-33 | 0.05 | 0.05 | 0.06 |
| Catalyst | ZF-10 | 0.04 | 0.04 | 0.07 |
| Catalyst | TCAT 110 | 0.403 | 0.405 | 0.254 |
| Foam Processing | GM-210 or SP-370 | 0 | 0 | 2.1 |
| Aid | | | | |
| FR Agent | FM-552 | 11 | 11 | 11 |
| Dye | X-15/X-38 | 0.05 | 0.05 | 0.05 |

TABLE 6C

| | | Formulation G | Formulation H | Formulation I |
|---|---|---|---|---|
| Component | Example | Amount (pph) | Amount (pph) | Amount (pph) |
| Polyol | VORANOL 3136 | 100 | 100 | 100 |
| | or 3137A | | | |
| Isocyanate | T-80 | 54.13 | 59.3 | 58.65 |
| Strut Reinforcing | 500N | 3 | 3 | 3 |
| Agent | | | | |
| Blowing Agent | Water | 4 | 4.15 | 4.14 |
| Surfactant | L-618 or L-650 | 1 | 1 | 1 |
| Catalyst | A-33 | 0.074 | 0.1 | 0.1 |
| Catalyst | ZF-10 | 0.077 | 0.059 | 0.059 |
| Catalyst | TCAT 110 or K-29 | 0.26 | 0.187 | 0.271 |
| Foam Processing | GM-210 or SP-370 | 2.1 | 2.1 | 2.1 |
| Aid | | | | |
| FR Agent | FM-552 | 11 | 11 | 11 |
| Dye | X-15/X-38 | 0.05 | 0.05 | 0.05 |

Formulation A was determined to have an isocyanate index of about 101 and produced acceptable strut-reinforced foam having an IFD between about 27 pounds and about 31 pounds and a density between about 1.4 pcf and about 1.5 pcf.

Formulation B was run under process conditions which included a relative humidity of 56 grains of moisture. The formulation was determined to have an isocyanate index of about 101 and produced acceptable strut-reinforced foam having an IFD of about 30.1 pounds, a density of about 1.56 pcf, and an air permeability of about 4.5 cfm.

Formulation C was run under process conditions which included a relative humidity of 49 grains of moisture. The formulation was determined to have an isocyanate index of about 100 and produced acceptable strut-reinforced foam having an IFD of about 31 pounds, a density of about 1.52 pcf, and an air permeability of about 5 cfm.

Formulation D was run under process conditions which included a relative humidity of 27 grains of moisture. The formulation was determined to have an isocyanate index of about 98 and produced acceptable strut-reinforced foam having an IFD of about 35.5 pounds, a density of about 1.49 pcf, and an air permeability of about 4 cfm.

Formulation E was run under process conditions which included a relative humidity of 46 grains of moisture. The formulation was determined to have an isocyanate index of about 98 and produced acceptable strut-reinforced foam having an IFD of about 35.9 pounds, a density of about 1.45 pcf, and an air permeability of about 4 cfm.

Formulation F was run under process conditions which included a relative humidity of 27 grains of moisture. The formulation was determined to have an isocyanate index of about 101 and produced acceptable strut-reinforced foam having an IFD of about 28 pounds, a density of about 1.41 pcf, and an air permeability of about 4 cfm.

Formulation G was run under process conditions which included a relative humidity of about 24 grains of moisture. The formulation was determined to have an isocyanate index of about 101 and produced acceptable strut-reinforced foam having an IFD of about 29.2 pounds, a density of about 1.54 pcf, and an air permeability of about 5 cfm.

Formulation H was run under process conditions which included a relative humidity of about 107 grains of moisture. The formulation was determined to have an isocyanate index of about 108 and produced acceptable strut-reinforced foam having an IFD between about 27 pounds and about 31 pounds and a density between about 1.4 pcf and about 1.5 pcf.

Formulation I was run under process conditions which included a relative humidity of about 70 grains of moisture. The formulation was determined to have an isocyanate index of about 104.5 and produced acceptable strut-reinforced foam having an IFD between about 27 pounds and about 31 pounds and a density between about 1.4 pcf and about 1.5 pcf.

The fatigue resistance of the strut-reinforced foam was tested and subsequently compared to two other foams with similar densities and firmness. More specifically, the strut-reinforced foam produced using Formulation A of Example 6 was compared to (a) a conventional foam having an ICD of about 30 pounds and a density of about 1.5 pcf and (b) a similar conventional foam produced in accordance with the process described and illustrated in U.S. Pat. No. 6,716,890 and marketed under the trade name REFLEX PLUSH® by Foamex International, Inc. of Linwood, Pa. Samples of the three types of foams were tested using the procedure described in ASTM 3574-01 “Standard Method of Testing Cellular Materials—Slab, Bonded, and Molded Urethane Foam.” The three samples were tested for two properties: 65% IFD and 25% IFD. Measurements of the 65% IFD and the 25% IFD for each of the foam samples were taken using an automated AVATAR compression testing machine.

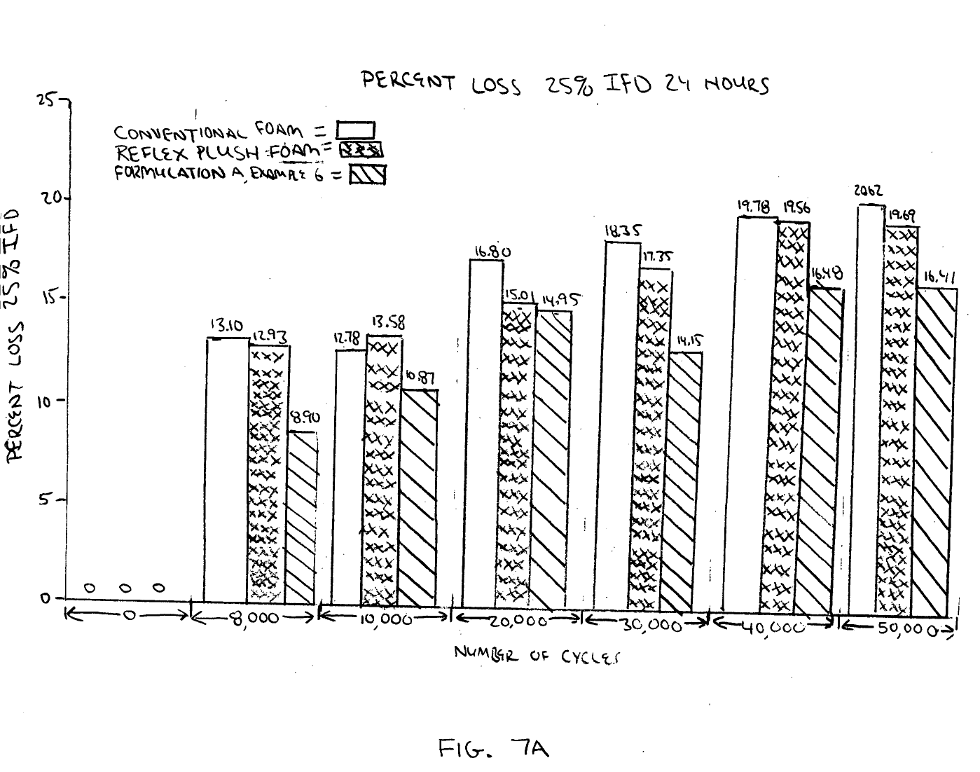

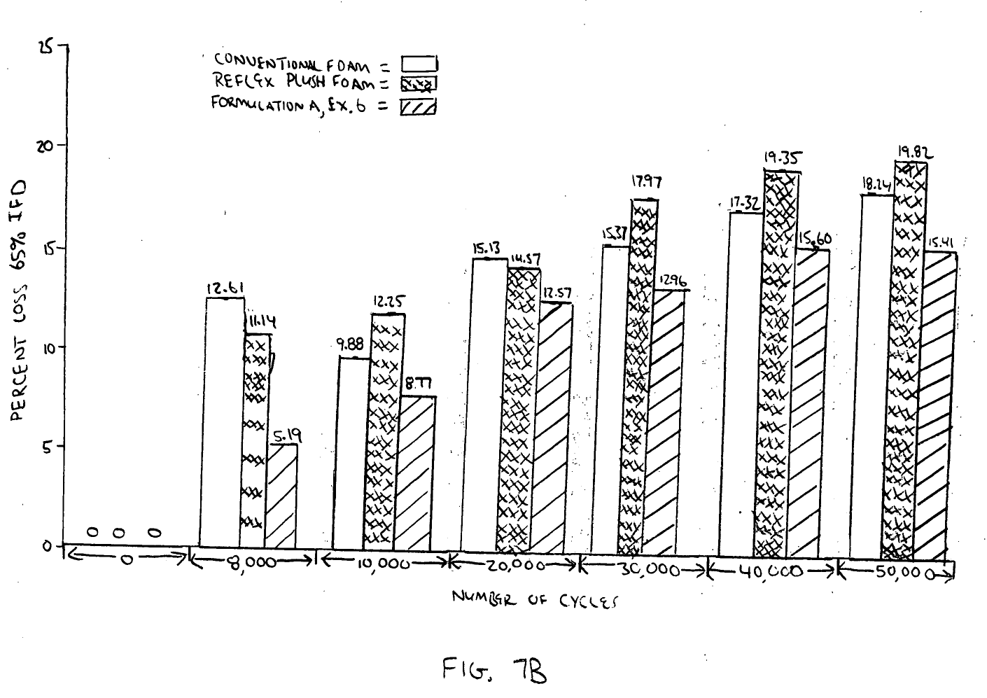

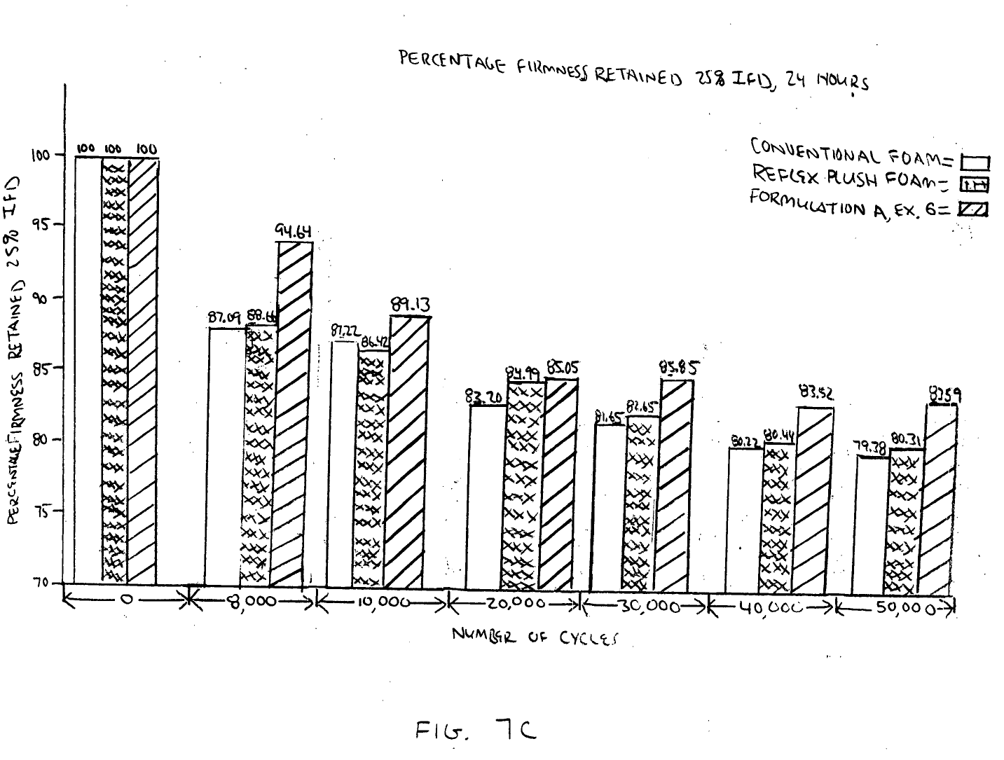

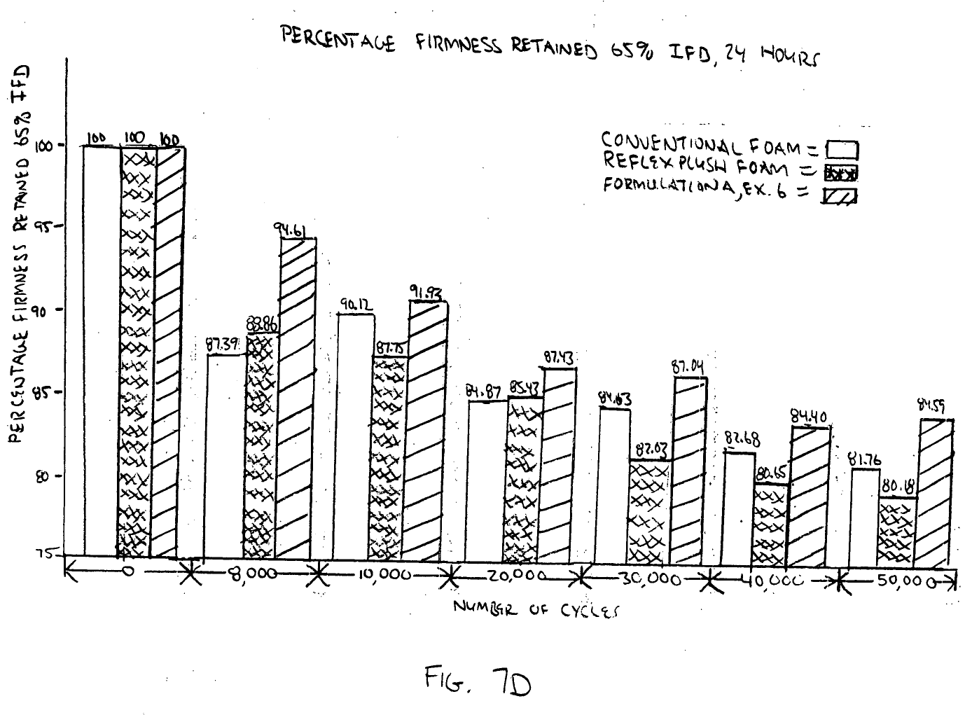

In the test, a plate having an 8 inch diameter applied a load at the general center of each foam sample at a rate of 2 inches per minute. The test was performed with a one pound per load. After recording the initial measurements, the cushions were subjected to cyclic loading at 170 pounds for 50,000 cycles at a rate of 35 cycles per minute with a 10 inch diameter indenter foot. The 25% IFD and 65% IFD properties were measured 24 hours after fatiguing at the following intervals: 8,000 cycles, 10,000 cycles, 20,000 cycles, 30,000 cycles, 40,000 cycles, and 50,000 cycles. Table 6D sets forth the percentage loss of the 25% IFD of the three samples recorded during the testing process. The percentage loss of the 25% IFD is graphically illustrated in FIG. 7A. Table 6E sets forth the percentage loss of the 65 % IFD of the three samples recorded during the testing process. The percentage loss of the 65% IFD is graphically illustrated in FIG. 7B. Table 6F sets forth the percentage retained of the 25% IFD of the three samples recorded during the testing process. The percentage retained of the 25% IFD is graphically illustrated in FIG. 7C. Finally, Table 6G sets forth the percentage retained of the 65% IFD of the three samples recorded during the testing process. The percentage retained of the 65% IFD is graphically illustrated in FIG. 7D.

TABLE 6D
Fatigue Test - 24 Hours After Fatiguing (Percent Loss of 25% IFD)

| | Cycles | | | | | | |
|---|---|---|---|---|---|---|---|
| | 0 | 8,000 | 10,000 | 20,000 | 30,000 | 40,000 | 50,000 |
| Conventional Foam | 0 | 13.10 | 12.78 | 16.80 | 18.35 | 19.78 | 20.62 |
| Example 6, Formulation A | 0 | 8.90 | 10.87 | 14.95 | 14.15 | 16.48 | 16.41 |
| Reflex Plush | 0 | 12.93 | 13.58 | 15.01 | 17.35 | 19.56 | 19.69 |

TABLE 6E
Fatigue Test - 24 Hours After Fatiguing (Percent Loss of 65% IFD)

| | Cycles | | | | | | |
|---|---|---|---|---|---|---|---|
| | 0 | 8,000 | 10,000 | 20,000 | 30,000 | 40,000 | 50,000 |
| Conventional Foam | 0 | 12.61 | 9.88 | 15.13 | 15.37 | 17.32 | 18.24 |
| Example 6, Formulation A | 0 | 5.39 | 8.07 | 12.57 | 12.96 | 15.60 | 15.41 |
| Reflex Plush | 0 | 11.14 | 12.25 | 14.57 | 17.97 | 19.35 | 19.82 |

TABLE 6F
Fatigue Test - 24 Hours After Fatiguing (Percent Retention of 25% IFD)

| | Cycles | | | | | | |
|---|---|---|---|---|---|---|---|
| | 0 | 8,000 | 10,000 | 20,000 | 30,000 | 40,000 | 50,000 |
| Conventional Foam | 100 | 86.90 | 87.22 | 83.20 | 81.65 | 80.22 | 79.38 |
| Example 6, Formulation A | 100 | 91.10 | 89.13 | 85.05 | 85.85 | 83.52 | 83.59 |
| Reflex Plush | 100 | 87.07 | 86.42 | 84.99 | 82.65 | 80.44 | 80.31 |

TABLE 6G
Fatigue Test - 24 Hours After Fatiguing (Percent Retention of 65% IFD)

| | Cycles | | | | | | |
|---|---|---|---|---|---|---|---|
| | 0 | 8,000 | 10,000 | 20,000 | 30,000 | 40,000 | 50,000 |
| Conventional Foam | 100 | 87.39 | 90.12 | 84.87 | 84.63 | 82.68 | 81.76 |
| Example 6, Formulation A | 100 | 94.61 | 91.93 | 87.43 | 87.04 | 84.40 | 84.59 |
| Reflex Plush | 100 | 88.86 | 87.75 | 85.43 | 82.03 | 80.65 | 80.18 |

As can be seen from an examination of Tables 6D-G and FIGS. 7A-D, the strut reinforced foam produced from Formulation A of Example 6 is superior to both conventional polyurethane foam and the REFLEX PLUSH® polyurethane foam. More specifically, testing consistently indicated that the strut-reinforced polyurethane foam produced from Formulation A of Example 6 has increased fatigue resistance when compared to conventional polyurethane foam or REFLEX PLUSH® polyurethane foam. As a result, when compared to conventional polyurethane foams, the strut-reinforced polyurethane foam produced from Formulation A of Example 6 will, over a period of time, retain more of its original firmness. Without being construed in the limiting sense, it is believed that the increased fatigue resistance evidenced hereinabove is a direct result of the relocation of polymer material from the membranes and the partial membranes onto the struts of the polyurethane foam which results from the inclusion of a strut-reinforcing agent in the formulation.

### EXAMPLE SEVEN

In further embodiments thereof, a strut-reinforced foam was produced using the formulations set forth in Tables 7A, 7B, and 7C.

TABLE 7A

| | | Formulation A | Formulation B | Formulation C |
|---|---|---|---|---|
| Component | Example | Amount (pph) | Amount (pph) | Amount (pph) |
| Polyol | VORANOL 3136 | 100 | 100 | 100 |
| | or 3137A | | | |
| Isocyanate | T-80 | 54.88 | 56.41 | 55.64 |
| Strut Reinforcing | 500N | 3 | 3 | 3 |
| Agent | | | | |
| Blowing Agent | Water | 4.75 | 4.85 | 4.8 |
| Surfactant | L-618 or L-650 | 0.95 | 0.95 | 0.95 |
| Catalyst | A-33 | 0.05 | 0.05 | 0.05 |
| Catalyst | ZF-10 | 0.04 | 0.04 | 0.04 |
| Catalyst | TCAT 110 | 0.369 | 0.369 | 0.357 |
| FR Agent | FM-552 | 11 | 11 | 11 |
| Dye | X-15/X-96 | 0.05 | 0.05 | 0.05 |

TABLE 7B

| | | Formulation D | Formulation E | Formulation F |
|---|---|---|---|---|
| Component | Example | Amount (pph) | Amount (pph) | Amount (pph) |
| Polyol | VORANOL | 100 | 100 | 100 |
| | 3136 or 3137A | | | |
| Isocyanate | T-80 | 55.76 | 54.54 | 54.67 |
| Strut Reinforcing | 500N | 3 | 3 | 3 |
| Agent | | | | |
| Blowing Agent | Water | 4.7 | 4.7 | 4.7 |
| Surfactant | L-618 or L-650 | 0.95 | 0.95 | 0.95 |
| Catalyst | A-33 | 0.05 | 0.05 | 0.05 |
| Catalyst | ZF-10 | 0.04 | 0.04 | 0.04 |
| Catalyst | TCAT 110 | 0.342 | 0.369 | 0.369 |
| FR Agent | FM-552 | 11 | 11 | 11 |
| Dye | X-15/X-96 | 0.05 | 0.05 | 0.05 |

TABLE 7C

| | | Formulation G |
|---|---|---|
| Component | Example | Amount (pph) |
| Polyol | VORANOL | 100 |
| | 3136 or 3137A | |
| Isocyanate | T-80 | 54.67 |
| Strut Reinforcing | 500N | 3 |
| Agent | | |
| Blowing Agent | Water | 4.7 |
| Surfactant | L-618 or L-650 | 0.95 |
| Catalyst | A-33 | 0.05 |
| Catalyst | ZF-10 | 0.04 |
| Catalyst | TCAT 110 | 0.369 |
| FR Agent | FM-552 | 11 |
| Dye | X-15/X-96 | 0.05 |

Formulation A was run under processing conditions that included a relative humidity of about 35 grains of moisture. The formulation was determined to have an isocyanate index of about 100 and produced acceptable strut-reinforced foam having an IFD between about 28 pounds and about 33 pounds, specifically about 30.5 pounds, a density between about 1.45 pcf and about 1.55 pcf, specifically about 1.43 pcf, and an air permeability of about 5 cfm.

Formulation B was run under processing conditions that included a relative humidity of about 41 grains of moisture. The formulation was determined to have an isocyanate index of about 101 and produced acceptable strut-reinforced foam having an IFD of about 31.6 pounds, a density of about 1.45 pcf, and an air permeability of 5 about cfm.

Formulation C was run under processing conditions that included a relative humidity of about 34 grains of moisture. The formulation was determined to have an isocyanate index of about 101 and produced acceptable strut-reinforced foam having an IFD of about 29.5 pounds, a density of about 1.42 pcf and an air permeability of 6 cfm.

Formulation D was run under processing conditions that included a relative humidity of about 48 grains of moisture. The formulation was determined to have an isocyanate index of about 103 and produced acceptable strut-reinforced foam having an IFD of about 32.4 pounds, a density of about 1.48 pcf and an air permeability of 4.5 cfm.

Formulation E was run under processing conditions that included a relative humidity of about 22 grains of moisture. The formulation was determined to have an isocyanate index of about 101 and produced acceptable strut-reinforced foam with an IFD of about 33 pounds, a density of about 1.47 pcf and an air permeability of about 4 cfm.

Formulation F was run under processing conditions that included a relative humidity of about 35 grains of moisture. The formulation was determined to have an isocyanate index of about 101 and produced acceptable strut-reinforced foam having an IFD of about 31.3 pounds, a density of about 1.39 pcf, and an air permeability of 4 cfm.

Formulation G was run under processing conditions that included a relative humidity of about 35 grains of moisture. The formulation was determined to have an isocyanate index of about 101 and produced acceptable strut-reinforced foam having an IFD of about 29.9 pounds, a density of about 1.51 pcf, and an air permeability of 4 cfm.

### EXAMPLE EIGHT

In further embodiments thereof, a strut-reinforced foam was prepared using the formulations set forth in Tables 8A and 8B.

TABLE 8A

| | | Formulation A | Formulation B | Formulation C |
|---|---|---|---|---|
| Component | Example | Amount (pph) | Amount (pph) | Amount (pph) |
| Polyol | VORANOL 3136 | 100 | 100 | 100 |
| | or 3137A | | | |
| Isocyanate | T-80 | 58.42 | 57.45 | 57.30 |
| Strut Reinforcing | 500N | 3 | 3 | 3 |
| Agent | | | | |
| Blowing Agent | Water | 4.8 | 4.8 | 4.8 |
| Surfactant | L-618 or L-650 | 0.95 | 0.95 | 0.95 |
| Catalyst | A-33 | 0.05 | 0.05 | 0.045 |
| Catalyst | ZF-10 | 0.04 | 0.04 | 0.045 |
| Catalyst | TCAT 110 | 0.295 | 0.317 | 0.342 |
| FR Agent | FM-552 | 11 | 11 | 11 |
| Dye | X-15/X-38 | 0.05 | 0.05 | 0.05 |

TABLE 8B

| | | Formulation D | Formulation E |
|---|---|---|---|
| Component | Example | Amount (pph) | Amount (pph) |
| Polyol | VORANOL 3136 | 100 | 100 |
| | or 3137A | | |
| Isocyanate | T-80 | 57.58 | 57.52 |
| Strut Reinforcing | 500N | 3 | 3 |
| Agent | | | |
| Blowing Agent | Water | 4.8 | 4.7 |
| Surfactant | L-618 or L-650 | 0.95 | 1.1 |
| Catalyst | A-33 | 0.05 | 0.05 |
| Catalyst | ZF-10 | 0.04 | 0.043 |
| Catalyst | TCAT 110 or K-29 | 0.333 | 0.317 |
| FR Agent | FM-552 | 11 | 12 |
| Dye | X-15/X-38 | 0.05 | 0.05 |

Formulation A was determined to have an isocyanate index of about 106 and produced acceptable strut-reinforced foam with an IFD of about 37.9 pounds, a density of about 1.45 pcf, and an air permeability of about 5 cfm.

Formulation B was determined to have an isocyanate index of about 104 and produced acceptable strut-reinforced foam with an IFD of about 33.9 pounds, a density of about 1.45 pcf, and an air permeability of about 4 cfm.

Formulation C was run under processing conditions that included a relative humidity of about 23 grains of moisture. The formulation was determined to have an isocyanate index of about 104 and produced acceptable strut-reinforced foam having an IFD of about 35.9 pounds, a density of about 1.42 pcf, and an air permeability of about 4.5 cfm.

Formulation D was run under processing conditions that included a relative humidity of about 37 grains of moisture. The formulation was determined to have an isocyanate index of about 104 and produced acceptable strut-reinforced foam having an IFD of about 35.9 pounds, a density of about 1.38 pcf, and an air permeability of about 5 cfm.

Formulation E was run under processing conditions that included a relative humidity of about 45 grains of moisture. The formulation was determined to have an isocyanate index of about 104 and produced acceptable strut-reinforced foam having an IFD of about 36.2 pounds, a density of about 1.46 pcf, and an air permeability of about 4 cfm.

### EXAMPLE NINE

In another embodiment thereof, a strut-reinforced foam was produced using the formulation set forth below in Table 9.

TABLE 9

| Component | Example | Amount (pph) |
|---|---|---|
| Polyol | VORANOL 3136A | 100 |
| Isocyanate | T-80 | 58.38 |
| Strut Reinforcing Agent | 500N | 3 |
| Blowing Agent | Water | 4.14 |
| Surfactant | L-650 | 1 |
| Catalyst | A-33 | 0.1 |
| Catalyst | ZF-10 | 0.059 |
| Catalyst | K-29 | 0.278 |
| Foam Processing Aid | SP-370 | 2.1 |
| FR Agent | FM-552 | 11 |
| Dye | X-15/X-38 | 0.05 |

The formulation set forth in Table 9 was determined to have an isocyanate index of about 100.5 and produced acceptable strut-reinforced foam having an IFD of about 29.6 pounds, a density of about 1.44 pcf, and an air permeability of about 4 cfm.

### EXAMPLE TEN

In another embodiment thereof, a strut-reinforced foam was produced using the formulation set forth below in Table 10.

TABLE 10

| Component | Example | Amount (pph) |
|---|---|---|
| Polyol | VORANOL 3136A | 100 |
| Isocyanate | T-80 | 49.16 |
| Strut Reinforcing Agent | 500N | 4 |
| Blowing Agent | Water | 3.2 |
| Surfactant | L-650 | 0.9 |
| Catalyst | A-33 | 0.057 |
| Catalyst | ZF-10 | 0.065 |
| Catalyst | K-29 | 0.299 |
| Foam Processing Aid | SP-370 | 2.3 |
| FR Agent | FM-552 | 11 |
| Dye | X-15/X-38 | 0.043 |

The formulation set forth in Table 10 was determined to have an isocyanate index of about 103.8 and produced acceptable strut-reinforced foam having an IFD between about 32 pounds and about 36 pounds and a density between about 1.67 pcf and about 1.77 pcf.

### EXAMPLE ELEVEN

In another embodiment thereof, a strut-reinforced foam was produced using the formulation set forth below in Table 11.

TABLE 11

| Component | Example | Amount (pph) |
|---|---|---|
| Polyol | VORANOL 3136A | 100 |
| Isocyanate | T-80 | 55.37 |
| Strut Reinforcing Agent | 500N | 4 |
| Blowing Agent | Water | 3.48 |
| Surfactant | L-650 | 0.9 |
| Catalyst | A-33 | 0.063 |
| Catalyst | ZF-10 | 0.065 |
| Catalyst | K-29 | 0.19 |
| Foam Processing Aid | SP-370 | 2 |
| FR Agent | FM-552 | 12 |
| Dye | X-15/X-38 | 0.043 |

The formulation set forth in Table 10 was determined to have an isocyanate index of about 109.75 and produced an acceptable strut-reinforced foam having an IFD of about 35.4 pounds, a density of about 1.68 pcf, and an air permeability of about 4 cfm.

### EXAMPLE TWELVE

In another embodiment thereof, a strut-reinforced foam was produced using the formulation set forth below in Table 12.

TABLE 12

| Component | Example | Amount (pph) |
|---|---|---|
| Polyol | VORANOL 3136A | 78 |
| Polyol | Alcupol | 22 |
| Isocyanate | T-80 | 53.81 |
| Strut Reinforcing Agent | 500N | 4 |
| Blowing Agent | Water | 4.34 |
| Surfactant | L-650 | 0.9 |
| Catalyst | A-33 | 0.05 |
| Catalyst | ZF-10 | 0.06 |
| Catalyst | K-29 | 0.293 |
| FR Agent | FM-552 | 12 |
| Dye | X-15/X-38 | 0.043 |

The formulation set forth in Table 12 was determined to have an isocyanate index of about 107 and produced an acceptable strut-resistant foam having an IFD of about 42.6 pounds, a density of about 1.71 pcf, and an air permeability of about 4 cfm.

### EXAMPLE THIRTEEN

In another embodiment, a strut-reinforced foam was produced using the formulation set forth below in Table 13.

TABLE 13

| Component | Example | Amount (pph) |
|---|---|---|
| Polyol | VORANOL 3136A | 70 |
| Polyol | Repsol Alcupol | 30 |
| Isocyanate | T-80 | 54.13 |
| Strut Reinforcing Agent | 500N | 4 |
| Blowing Agent | Water | 4.05 |
| Surfactant | L-650 | 0.9 |
| Catalyst | A-33 | 0.05 |
| Catalyst | ZF-10 | 0.06 |
| Catalyst | K-29 | 0.272 |
| FR Agent | FM-552 | 11 |
| Dye | X-64 | 0.009 |

The formulation set forth in Table 13 was determined to have an isocyanate index of about 113.5 and produced acceptable strut-reinforced foam having an IFD of about 46.5 pounds, a density of about 1.71 pcf, and an air permeability of about 4 cfm.

### EXAMPLE FOURTEEN

In another embodiment thereof, a strut-reinforced foam was prepared using the formulation set forth below in Table 14.

TABLE 14

| Component | Example | Amount (pph) |
|---|---|---|
| Polyol | VORANOL 3136A | 88.5 |
| Polyol | VORANOL 4001 | 10 |
| Foam Processing Aid | DP-1022 | 1.5 |
| Isocyanate | T-80 | 42.52 |
| Strut Reinforcing | 500N | 5 |
| Agent | | |
| Blowing Agent | Water | 3.03 |
| Surfactant | L-618 | 1.25 |
| Catalyst | A-33 | 0.05 |
| Catalyst | A-133 | 0.29 |
| Catalyst | K-29 | 0.154 |

The formulation set forth in Table 14 was determined to have an isocyanate index of about 102 and produced an acceptable strut-reinforced foam having an IFD of about 33.8 pounds, a density of about 2.01 pcf, and an air permeability of about 4 cfm.

While a number of preferred embodiments have been shown and described herein, modifications thereof may be made by one skilled in the art without departing from the spirit and the teachings of the invention. The embodiments described herein are exemplary only and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

What is claimed is:

1. A polyurethane foam produced from a formulation comprising:
a polyol;
an isocyanate, said isocyanate reacting with said polyol to produce a polyurethane foam; and
a strut reinforcing agent;
wherein inclusion of said strut reinforcing agent in said formulation during said reaction between said isocyanate and said polyol enhances air permeability of said polyurethane foam produced thereby relative to a polyurethane foam produced by reacting said isocyanate and said polyol in the absence of said strut reinforcing agent.

2. The polyurethane foam of claim 1 wherein said strut reinforcing agent is an aromatic hydrocarbon.

3. The polyurethane foam of claim 1 wherein said strut reinforcing agent is an aromatic hydrocarbon comprising at least about 10 carbon atoms.

4. The polyurethane foam of claim 1 wherein said strut reinforcing agent is an organic chemical compound comprising at least about 10 carbon atoms.

5. The polyurethane foam of claim 1, wherein said the strut reinforcing agent is a mineral oil.

6. The polyurethane foam of claim 1, wherein said strut reinforcing agent is paraffin.

7. The polyurethane foam of claim 1, wherein said strut reinforcing agent is naphthalene.

8. The polyurethane foam of claim 1, wherein the strut reinforcing agent is a vegetable oil.

9. A polyurethane foam produced from a formulation comprising:
a polyol;
an isocyanate, said isocyanate reacting with said polyol to produce a polyurethane foam; and
a strut reinforcing agent;
wherein inclusion of said strut reinforcing agent in said formulation during said reaction between said isocyanate and said polyol enhances firmness of said polyurethane foam produced thereby relative to a polyurethane foam produced by reacting said isocyanate and said polyol in the absence of said strut reinforcing agent.

10. The polyurethane foam of claim 9 wherein said strut reinforcing agent is an aromatic hydrocarbon.

11. The polyurethane foam of claim 9 wherein said strut reinforcing agent is an aromatic hydrocarbon comprising at least about 10 carbon atoms.

12. The polyurethane foam of claim 9 wherein said strut reinforcing agent is an organic chemical compound comprising at least about 10 carbon atoms.

13. The polyurethane foam of claim 9, wherein said the strut reinforcing agent is a mineral oil.

14. The polyurethane foam of claim 9, wherein said strut reinforcing agent is paraffin.

15. The polyurethane foam of claim 9, wherein said strut reinforcing agent is naphthalene.

16. The polyurethane foam of claim 9, wherein the strut reinforcing agent is a vegetable oil.

17. A polyurethane foam produced from a formulation comprising:
about 100 parts of a polyol;
between about 40 parts and about 60 parts of an isocyanate, said isocyanate reacting with said polyol to produce a polyurethane foam; and
between about 2 parts and about 8 parts of a strut reinforcing agent, said strut reinforcing agent non-reactive relative to said polyol and said isocyanate.
wherein inclusion of said strut reinforcing agent in said formulation during said reaction between said isocyanate and said polyol enhances air permeability and firmness of said polyurethane foam produced thereby relative to a polyurethane foam produced by reacting said isocyanate and said polyol in the absence of said strut reinforcing agent.

18. The polyurethane foam of claim 17, wherein the formulation further comprises: between about 0.01 parts and about 3 parts of a surfactant.
